(19) United States
(12) Patent Application Publication
(10) Pub. No.: US 2020/0221130 A1
(43) Pub. Date: Jul. 9, 2020

(54) METHOD AND DEVICE FOR PERFORMING TRANSFORM USING LAYERED GIVENS TRANSFORM

(71) Applicant: LG ELECTRONICS INC., Seoul (KR)

(72) Inventor: Moonmo KOO, Seoul (KR)

(21) Appl. No.: 16/643,786

(22) PCT Filed: Sep. 3, 2018
(86) PCT No.: PCT/KR2018/010230

§ 371 Date: Mar. 2, 2020

Related U.S. Application Data
(60) Provisional application No. 62/553,895, filed on Sep. 3, 2017.

(51) Int. Cl. H04N 19/60; H04N 19/88; H04N 19/14; H04N 19/119; H04N 19/169; G06F 17/16

(52) U.S. Cl. CPC H04N 19/649; H04N 19/88; G06F 17/16; H04N 19/119; H04N 19/1883; H04N 19/14

(57) ABSTRACT

Disclosed herein is a method for performing decoding using a Layered Givens Transform (LGT), which includes: deriving a plurality of rotation layers and at least one permutation layer, wherein the rotation layer includes a permutation matrix and a rotation matrix, and the rotation matrix includes at least one pairwise rotation matrix; acquiring an LGT coefficient using the plurality of rotation layers and the at least one permutation layer; and performing inverse transform using the LGT coefficient, in which the rotation layer may be derived based on edge information indicating a pair to which the at least one pairwise rotation matrix is applied.

### TECHNICAL FIELD

The present disclosure relates to a method and device for encoding/decoding a video signal and, more particularly, to a technology for approximating a given target transform using a layered Givens transform.

### BACKGROUND ART

Compression encoding means a series of signal processing technologies for transmitting digitized information through a communication line or storing the information in a form suitable for a storage medium. Media, such as a picture, an image and voice, may be the subject of compression encoding. In particular, a technology performing compression encoding on an image is called video image compression.

Next-generation video content will have features of high spatial resolution, a high frame rate, and high dimensionality of scene representation. Processing such content will result in a tremendous increase in terms of memory storage, a memory access rate, and processing power. Therefore, there is a need to design a coding tool for processing next-generation video content more efficiently.

In particular, many image processing and compressing schemes have adapted separable transforms. For example, a Discrete Cosine Transform (DCT) provides good approximation to a Karhunen-Loeve transform (KLT) in response to a high inter pixel correlation, and it is used widely due to low complexity. Regardless of use of separable transforms, natural image compression has very different statistical properties, so better compression may be performed only by means of a complex transform applicable to variable statistical properties of signal blocks.

Actual implementations have been so far focused on separable approximation of such transforms in order to provide a low-complex reasonable coding gain. For example, a mode-dependent transform scheme is designed such that a separable KLT reduces complexity of a non-separable KLT for each mode. In another example, an asymmetric discrete sine transform (ADST) is integrated into a hybrid DCT/ADST scheme and designing a separable sparse orthonormal transform and the like has been considered.

### DISCLOSURE

### Technical Problem

An object of the present disclosure proposes a method of designing a transform having significantly low computational complexity while showing compression performance similar to a target transform of high computational complexity.

Furthermore, an object of the present disclosure proposes a method for designing a Layered Givens Transform approximate to a target transform when the target transform is given.

Furthermore, an object of the present disclosure proposes a method for more efficiently designing a Non-Separable Secondary Transform using a Layered Givens Transform.

Furthermore, an object of the present disclosure proposes a method for more efficiently describing edges constituting a Givens rotation layer when a plurality of edge sets are predefined.

Furthermore, an object of the present disclosure proposes a method for allocating an index per edge set or edge set group and describing a Givens rotation layer constituting a Layered Givens Transform based on the allocated index.

Furthermore, an object of the present disclosure proposes a method for designating rotation or reflection for every Givens rotation.

Furthermore, an object of the present disclosure proposes a method for reducing multiplication operations by a dividing Givens rotation into products of a plurality of matrices.

The technical objects of the present disclosure are not limited to the aforementioned technical objects, and other technical objects, which are not mentioned above, will be apparently appreciated by a person having ordinary skill in the art from the following description.

### Technical Solution

In an aspect, provided is a method for performing decoding using a Layered Givens Transform (LGT), which includes: deriving a plurality of rotation layers and at least one permutation layer, wherein the rotation layer includes a permutation matrix and a rotation matrix, and the rotation matrix includes at least one pairwise rotation matrix; acquiring an LGT coefficient using the plurality of rotation layers and the at least one permutation layer; and performing inverse transform using the LGT coefficient, in which the rotation layer may be derived based on edge information indicating a pair to which the at least one pairwise rotation matrix is applied.

Preferably, the edge information may include one of indexes and each index corresponds to one of the plurality of rotation layers, and the one of indexes may indicate a specific edge set in a predefined edge set group.

Preferably, the deriving of the plurality of rotation layers and the permutation layer includes dividing the plurality of rotation layers into sublayer groups, the edge information may include one of indexes, each index corresponds to one of the sublayer groups, and the one of the indexes may indicate a specific edge set pattern among predefined edge set patterns and the edge set pattern may represent an edge set group in which an order between edge sets is determined.

Preferably, the edge information may include an index indicating a specific edge for each vertex of the rotation layer.

Preferably, the deriving of the plurality of rotation layers and the permutation layer may include dividing vertexes of the plurality of rotation layers into sub groups, and the edge information may include connection information between the sub groups and connection information between vertexes in the sub group.

Preferably, the deriving of the plurality of rotation layers and the permutation layer may include determining whether the pairwise rotation matrix is a rotation matrix or a reflection matrix.

In another aspect, provided is an apparatus performing decoding using Layered Givens Transform (LGT), which includes: a layer deriving unit deriving a plurality of rotation layers and at least one permutation layer, wherein the rotation layer includes a permutation matrix and a rotation matrix, and the rotation matrix includes at least one pairwise rotation matrix; an LGT coefficient acquiring unit acquiring an LGT coefficient using the plurality of rotation layers and the at least one permutation layer; and an inverse transform unit performing inverse transform using the LGT coefficient, in which the rotation layer may be derived based on edge information indicating a pair to which the at least one pairwise rotation matrix is applied.

Preferably, the edge information may include one of indexes and each index corresponds to one of the plurality of rotation layers, and the one of indexes may indicate a specific edge set in a predefined edge set group.

Preferably, the layer deriving unit may divide the plurality of rotation layers into sublayer groups, the edge information may include one of indexes, each index corresponding to one of the plurality of rotation layers, and the one of indexes may indicate a specific edge set pattern among predefined edge set patterns and the edge set pattern may represent an edge set group in which an order between edge sets is determined.

Preferably, the edge information may include an index indicating a specific edge for each vertex of the rotation layer.

Preferably, the layer deriving unit may divide vertexes of the plurality of rotation layers into sub groups, and the edge information may include connection information between the sub groups and connection information between vertexes in the sub group.

Preferably the layer deriving unit may determine whether the pairwise rotation matrix is a rotation matrix or a reflection matrix.

### Advantageous Effects

According to an embodiment of the present disclosure, by designing transform having the same or similar compression efficiency as or to target transform given in calculation complexity remarkably reduced compared with target transform, encoding performance can be increased.

According to an embodiment of the present disclosure, a graph expressing each Givens rotation layer can be described with an appropriate degree of freedom to minimize a bit amount for expressing the Givens rotation layer and increase transform performance.

Effects obtainable in the present disclosure are not limited to the aforementioned effects and other unmentioned effects will be clearly understood by those skilled in the art from the following description.

### DESCRIPTION OF DRAWINGS

FIG. 1 shows a schematic block diagram of an encoder for encoding a video signal according to one embodiment of the present disclosure.

FIG. 2 shows a schematic block diagram of a decoder for decoding a video signal according to one embodiment of the present disclosure.

FIG. 3a is a diagram for illustrating a split structure of a coding unit according to one embodiment of the present disclosure.

FIG. 3b is a diagram for describing a quad-tree binary-tree (QTBT) among split structures of a coding unit according to one embodiment of the present disclosure.

FIG. 4 is an embodiment to which the present disclosure is applied and is a diagram illustrating a method of arranging two-dimensional data blocks in the form of a one-dimensional array.

FIG. 5 is an embodiment to which the present disclosure is applied and is a diagram illustrating an example in which a permutation matrix is applied.

FIG. 6 is an embodiment to which the present disclosure is applied and is a diagram illustrating an example in which a rotation matrix is applied.

FIG. 7 is a diagram illustrating an example of a transform to which the present disclosure is applied.

FIG. 8 is an embodiment to which the present disclosure is applied and is a diagram illustrating a method of applying forward and backward layered Givens transforms.

FIG. 9 is an embodiment to which the present disclosure is applied and is a diagram illustrating a method of applying a rotation layer.

FIG. 10 is a diagram illustrating a calculation process of Layered Givens Transform according to one embodiment of the present disclosure.

FIG. 11 is a diagram illustrating one example of an edge expression scheme according to one embodiment of present disclosure.

FIG. 12 is a diagram illustrating a calculation process of Layered Givens Transform according to one embodiment of the present disclosure.

FIG. 13 is a diagram illustrating a method for hierarchically determining edge information of a Givens rotation layer according to one embodiment of the present disclosure.

FIG. 14 is a diagram illustrating a method for hierarchically determining edge information of a Givens rotation layer according to one embodiment of the present disclosure.

FIG. 15 is a diagram illustrating a method for hierarchically determining edge information of a Givens rotation layer according to one embodiment of the present disclosure.

FIG. 16 is a diagram illustrating a method for hierarchically determining edge information of a Givens rotation layer according to one embodiment of the present disclosure.

FIGS. 17 and 18 are diagrams illustrating application regions of a secondary transform according to one embodiment of the present disclosure.

FIG. 19 is a diagram illustrating application regions of a secondary transform according to one embodiment of the present disclosure.

FIG. 20 is a diagram illustrating application regions of a secondary transform according to one embodiment of the present disclosure.

FIG. 21 is a diagram illustrating application regions of a secondary transform according to one embodiment of the present disclosure.

FIG. 22 is a diagram illustrating an application region of a secondary transform according to one embodiment of the present disclosure.

FIG. 23 is a diagram illustrating an application region of a secondary transform according to one embodiment of the present disclosure.

FIG. 24 is a diagram illustrating a computation method of Givens rotation according to one embodiment of the present disclosure.

FIG. 25 is a flowchart for describing a process of performing transform using Layered Givens Transform according to one embodiment of the present disclosure.

FIG. 26 is a diagram more specifically illustrating a decoder according to the present disclosure.

FIG. 27 is a structure diagram of a content streaming system according to one embodiment of the present disclosure.

### MODE FOR INVENTION

Hereinafter, exemplary elements and operations in accordance with embodiments of the present disclosure are described with reference to the accompanying drawings, however, it is to be noted that the elements and operations of the present disclosure described with reference to the drawings are provided as only embodiments and the technical ideas and core elements and operation of the present disclosure are not limited thereto.

Furthermore, terms used in the present disclosure are common terms that are now widely used, but in special cases, terms randomly selected by the applicant are used. In such a case, the meaning of a corresponding term is clearly described in the detailed description of a corresponding part. Accordingly, it is to be noted that the present disclosure should not be construed as being based on only the name of a term used in a corresponding description of the present disclosure and that the present disclosure should be construed by checking even the meaning of a corresponding term.

Furthermore, terms used in the present disclosure are common terms selected to describe the invention, but may be replaced with other terms for more appropriate analysis if such terms having similar meanings are present. For example, a signal, data, a sample, a picture, a frame, and a block may be properly substituted and interpreted in each coding process. Further, partitioning, decomposition, splitting, and split, etc. may also be appropriately substituted and interpreted with each other for each coding process.

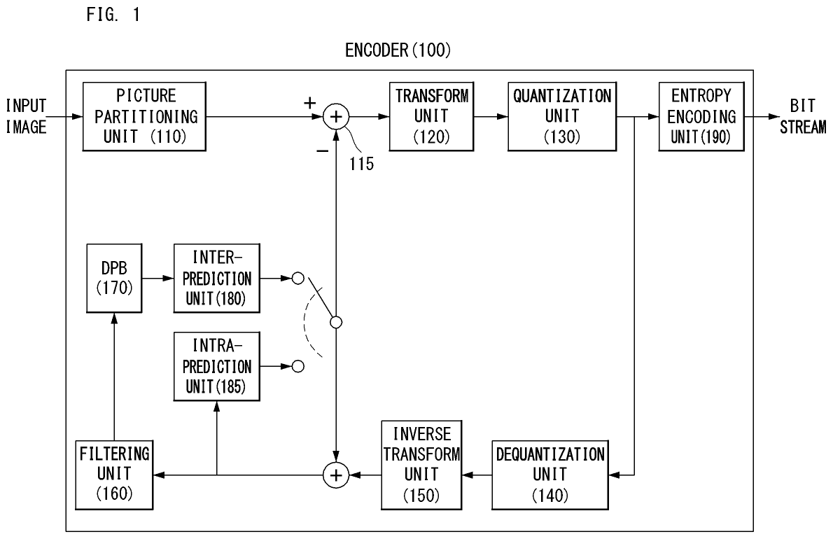

FIG. 1 shows a schematic block diagram of an encoder for encoding a video signal, according to one embodiment of the present disclosure.

Referring to FIG. 1, the encoder 100 may include an image segmentation unit 110, a transform unit 120, a quantization unit 130, a de-quantization unit 140, an inverse transform unit 150, a filtering unit 160, a decoded picture buffer (DPB) 170, an inter prediction unit 180, an intra prediction unit 185, and an entropy encoding unit 190.

The image segmentation unit 110 may divide an input image (or a picture or a frame) input to the encoder 100 into one or more process units. For example, the process unit may be a coding tree unit (CTU), a coding unit (CU), a prediction unit (PU) or a transform unit (TU).

However, the terms are used only for convenience of illustration of the present disclosure. The present disclosure is not limited to the definitions of the terms. In the present disclosure, for convenience of illustration, the term “coding unit” is used as a unit used in a process of encoding or decoding a video signal, but the present disclosure is not limited thereto. Another process unit may be appropriately selected based on the contents of the present disclosure.

The encoder 100 may generate a residual signal by subtracting a prediction signal output by the inter prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square or to a block of a variable size other than a square.

The quantization unit 130 quantizes the transform coefficient and transmits the quantized coefficient to the entropy encoding unit 190. The entropy encoding unit 190 may entropy-encode a quantized signal and output it as a bit stream.

The quantized signal output by the quantization unit 130 may be used to generate a prediction signal. For example, the quantized signal may reconstruct a residual signal by applying dequantization and an inverse transform through the dequantization unit 140 and the inverse transform unit 150 within the loop. A reconstructed signal may be generated by adding the reconstructed residual signal to the prediction signal output by the inter-prediction unit 180 or the intra-prediction unit 185.

Meanwhile, in such a compression process, artifacts in which a block boundary appears due to a quantization error because quantization is performed in a block unit may occur. Such a phenomenon are called blocking artifacts, which is one of important elements that evaluate picture quality. A filtering process may be performed in order to reduce such artifacts. Through such a filtering process, picture quality can be enhanced by removing blocking artifacts and also reducing an error of a current picture.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter prediction unit 180.

The inter prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter prediction unit 180 may interpolate signals between pixels on a subpixel basis using a low-pass filter. In this case, the subpixel may mean a virtual pixel generated by applying an interpolation filter. An integer pixel means an actual pixel within the reconstructed picture. The interpolation method may include linear interpolation, bi-linear interpolation and Wiener filter, etc.

The interpolation filter may be applied to the reconstructed picture to improve the accuracy of the prediction. For example, the inter prediction unit 180 may apply the interpolation filter to integer pixels to generate interpolated pixels. The inter prediction unit 180 may perform prediction using an interpolated block composed of the interpolated pixels as a prediction block.

Meanwhile, the intra prediction unit 185 may predict a current block by referring to samples in the vicinity of a block to be encoded currently. The intra prediction unit 185 may perform a following procedure to perform intra-prediction. First, the intra prediction unit 185 may prepare reference samples needed to generate a prediction signal. Thereafter, the intra prediction unit 185 may generate the prediction signal using the prepared reference samples. Thereafter, the intra prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The prediction signal generated via the inter prediction unit 180 or the intra prediction unit 185 may be used to generate the reconstructed signal or used to generate the residual signal.

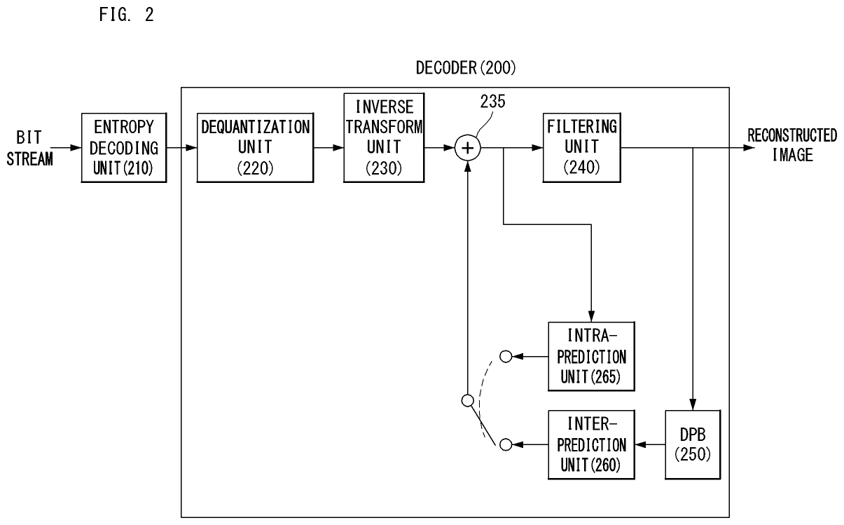

FIG. 2 shows a schematic block diagram of a decoder for decoding a video signal according to one embodiment of the present disclosure.

Referring to FIG. 2, the decoder 200 may include a parsing unit (not shown), an entropy decoding unit 210, a de-quantization unit 220, an inverse transform unit 230, a filtering unit 240, a decoded picture buffer (DPB) 250, an inter prediction unit 260 and an intra prediction unit 265.

A reconstructed video signal output by the decoder 200 may be reproduced using a playback device.

The decoder 200 may receive the signal output by the encoder as shown in FIG. 1. The received signal may be entropy-decoded via the entropy decoding unit 210.

The de-quantization unit 220 obtains a transform coefficient from an entropy-decoded signal using quantization step size information.

The inverse transform unit 230 obtains a residual signal by performing an inverse-transform for the transform coefficient.

A reconstructed signal may be generated by adding the obtained residual signal to the prediction signal output by the inter prediction unit 260 or the intra prediction unit 265.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter prediction unit 260.

In the present disclosure, the same embodiments described regarding the transform unit 120 and each function unit of the encoder 100 may be applied to the inverse transform unit 230 and any corresponding function unit of the decoder.

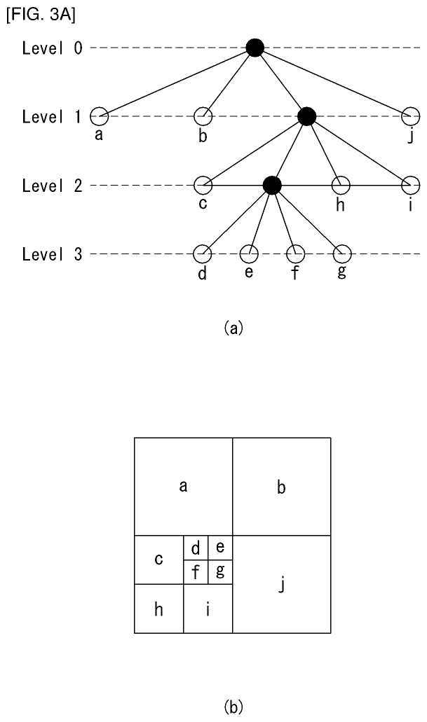

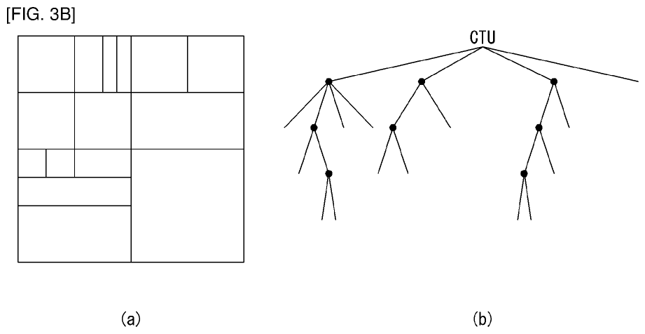

FIG. 3 is a diagram for describing a split structure of a coding unit according to one embodiment of the present disclosure.

The encoder may split one image (or picture) into units of a Coding Tree Unit (CTU) having a rectangular shape. In addition, respective CTUs are sequentially encoded according to a raster scan order.

For example, the size of the CTU may be determined as any one of 64×64, 32×32, and 16×16, but the present disclosure is not limited thereto. The encoder may select and use the size of the CTU according to a resolution of an input image or a characteristic of the input image. The CTU may include a Coding Tree Block (CTB) for a luma component and a Coding Tree Block (CTB) for two chroma components corresponding thereto.

One CTU may be decomposed into a quadtree (hereinafter, referred to as ‘QT’) structure. For example, one CTU may be split into four units having a square shape and in which each side is reduced by half in length. Decomposition of the QT structure may be recursively performed.

Referring to FIG. 3a, a root node of the QT may be associated with the CTU. The QT may be split until reaching a leaf node and in this case, the leaf node may be referred to as a Coding Unit (CU).

The CU may mean a basic unit of coding in which a input image processing process, e.g., intra/inter prediction is performed. The CU may include a Coding Block (CB) for the luma component and a CB for two chroma components corresponding thereto. For example, the size of the CU may be determined as any one of 64×64, 32×32, 16×16, and 8×8, but the present disclosure is not limited thereto and in the case of a high-resolution image, the size of the CU may be larger or diversified.

Referring to FIG. 3a, the CTU corresponds to the root node and has a smallest depth (i.e., level 0) value. The CUT may not be split according to the characteristic of the input image and in this case, the CTU corresponds to the CU.

The CTU may be decomposed into QT types, and as a result, lower nodes having a depth of level 1 may be generated. In addition, a node (i.e., the leaf node) which is not split any longer in the lower node having the depth of level 1 corresponds to the CU. For example, in (b) of FIG. 3a, CU(a), CU(b), and CU(j) corresponding to nodes a, b, and j are split once in the CTU and have the depth of level 1.

At least any one of the nodes having the depth of level 1 may be split into the QT types again. In addition, a node (i.e., the leaf node) which is not split any longer in a lower node having a depth of level 2 corresponds to the CU. For example, in (b) of FIG. 3a, CU(c), CU(h), and CU(i) corresponding to nodes c, h, and i are split twice in the CTU and have the depth of level 2.

Further, at least any one of the nodes having the depth of level 2 may be split into the QT types again. In addition, a node (i.e., the leaf node) which is not split any longer in a lower node having a depth of level 3 corresponds to the CU. For example, in (b) of FIG. 3a, CU(d), CU(e), CU(f), and CU(g) corresponding to nodes d, e, f, and g are split three times in the CTU and have the depth of level 3.

The encoder may determine a maximum size or a minimum size of the CU according to a characteristic (e.g., a resolution) of a video image or by considering efficiency of encoding. In addition, information thereon or information capable of deriving the same may be included in a bitstream. The CU having the maximum size may be referred to as a Largest Coding Unit (LCU) and the CU having the minimum size may be referred to as a Smallest Coding Unit (SCU).

Further, a CU having a tree structure may be hierarchically split with predetermined maximum depth information (alternatively, maximum level information). In addition, each split CU may have depth information. Since the depth information represents the number of splitting times and/or a splitting degree of the CU, the depth information may include information on the size of the CU.

Since the LCU is split into the QT type, when the size and the maximum depth information of the LCU is used, the size of the SCU may be obtained. Alternatively, conversely, when the size of the SCU and the maximum depth of the tree are used, the size of the SCU may be obtained.

For one CU, information representing whether the corresponding CU is split may be forwarded to the decoder. For example, the information may be defined as a split flag and expressed as a syntax element “split_cu_flag”. The split flag may be included in all CUs other than the SCU. For example, when a value of the split flag is ‘1’, the corresponding CU may be divided into four CUs again and when the value of the split flag is ‘0’, the corresponding CU is not divided any longer and the coding process for the corresponding CU may be performed.

In the embodiment of FIG. 3a above, a split process of the CU is described as an example, but the QT structure may be applied even to a split process of a Transform Unit (TU) which is a basic unit that performs transform.

The TU may be hierarchically split from a CU to be coded to the QT structure. For example, the CU may correspond to a root node of a tree for the transform unit (TU).

Since the TU is split into the QT structure, the TU split from the CU may be split into a smaller lower TU again. For example, the size of the TU may be determined as any one of 32×32, 16×16, 8×8, AND 4×4, but the present disclosure is not limited thereto and in the case of the high-resolution image, the size of the TU may be larger or diversified.

For one TU, information representing whether the corresponding TU is split may be forwarded to the decoder. For example, the information may be defined as a split transform flag and expressed as a syntax element “split_transform_flag”.

The split transform flag may be included in all TUs other than the TU having the minimum size. For example, when the value of the split transform flag is ‘1’, the corresponding TU is divided into four TUs again and when the value of the split transform flag is ‘1’, the corresponding TU is not divided any longer.

As described above, the CU is a basic unit of coding in which intra prediction or inter prediction is performed. In order to more effectively code the input image, the CU may be split into units of a Prediction Unit (PU).

The PU is a basic unit for generating a prediction block and the prediction blocks may be generated differently for respective PUs included in a same CU. The PU may be split differently according to whether an intra prediction mode or an inter prediction mode is used as a coding mode of a CU to which the PU belongs.

FIG. 3b is a diagram for describing a quad-tree binary-tree (QTBT) among split structures of a coding unit according to one embodiment of the present disclosure.

The encoder may split one image (or picture) into units of a coding tree unit (CTU) having a rectangular shape. In addition, respective CTUs are sequentially encoded according to a raster scan order.

One CTU may be decomposed into a quadtree (hereinafter, referred to as ‘QT’) structure and a binarytree (hereinafter, referred to as BT). For example, one CUT may be split into four units having a square shape and in which each side is reduced by half in length or split into two units having a rectangular shape and in which a width or a height is reduced by half in length. Decomposition of the QT/BT structure may be recursively performed.

Referring to FIG. 3b, a root node of the QT may be associated with the CTU. The QT may be split until reaching a QT leaf node and the QT leaf node may be split into BTs and split until reaching a BT leaf node.

Referring to FIG. 3b, the CTU corresponds to the root node and has a smallest depth (i.e., level 0) value. The CTU may not be split according to the characteristic of the input image and in this case, the CTU corresponds to the CU.

The CTU may be decomposed into the QT types and the QT leaf node may be split into the BT types. As a result, lower nodes having a depth of level n may be generated. In addition, a node (i.e., the leaf node) which is not split any longer in a lower node having a depth of level n corresponds to the CU.

For one CU, information representing whether the corresponding CU is split may be forwarded to the decoder. For example, the information may be defined as a split flag and expressed as a syntax element “split_cu_flag”. Further, information representing whether the corresponding CU is split into the BT in the QT leaf node may be forwarded to the decoder. For example, the information may be defined as a BT split flag and expressed as a syntax element “bt_split_flag”. When the CU may be split into the BTs by the bi_split_flag, a BT split shape may be forwarded to the decoder so as to be split into a rectangular type having a width of a half size or a rectangular type having a height of a half size. For example, the information may be defined as a BT split mode and expressed as a syntax element “bt_split_mode”.

Transform coding is one of the most important tools used for current image and video compression. A transform coefficient is generated by linearly transforming data using a transform. The generated transform coefficient is quantized and entropy-encoded and then transmitted to a decoder. The decoder reconstructs data by performing entropy decoding and dequantization and then inverse-transforming the transform coefficient using an inverse transform. In general, a transform is selected as an orthonormal transform that accepts a simple inverse transform and quantization. In particular, in the case of image and video data, it is very common to use a separable discrete cosine transform (DCT), a discrete sine transform (DST) and other similar transforms.

In the case of data of an N×N block, in general, a separable transform requires computation of N³. If a separable transform used has a fast implementation, a computation count is reduced to N²*log N.

In order to improve compression efficiency, it is important to make a transform coefficient independent statistically by designing the statistics of input data so that the statistics are matched more effectively. For example, compression can be improved using a Karhunen-Loeve transform (KLT) or a sparse orthonormal transform (SOT). However, such a transform corresponds to a non-separable transform having a difficult fast implementation. That is, if such a non-separable transform is to be applied, N⁴ computation is necessary.

The present disclosure proposes a method of designing a version having easy computation of a general transform. Specifically, the present disclosure proposes a method of designing a layered Givens transform (LGT) approximate to a target transform when the target transform is given.

According to the present disclosure, a transform having the same or similar compression efficiency as or to a given target transform in significantly reduced computational complexity compared to the target transform can be designed.

Hereinafter, the present disclosure will be described using a square block of N×N pixels. However, the present disclosure is not limited thereto and may be extended to non-square blocks, data of multiple dimensions and a non-pixel type in addition to the square block. Accordingly, a more adaptive transform can be performed.

In the present disclosure, a target transform H applicable to an N×N block may be approximated by a layered Givens transform configured with a combination of a rotation layer and a permutation layer. In the present disclosure, the layered Givens transform may be called a layered transform, but the present disclosure is not limited to the term.

Definition of Layered Givens Transform (LGT)

Hereinafter, a matrix expression of an N×N image or video block and transform is described. In the description of the present disclosure, it is assumed that N² is an even number, for convenience of description.

FIG. 4 is an embodiment to which the present disclosure is applied and is a diagram illustrating a method of arranging two-dimensional data blocks in the form of a one-dimensional array.

In order to apply a non-separable transform, two-dimensional (or two-dimensional array) data blocks may be arranged in the form of a one-dimensional array. For example, blocks of a 4×4 size may be arranged in row-first lexicographic order, as shown in FIG. 4. Furthermore, the blocks may be arranged in column order within each row. Although not shown in FIG. 4, the blocks may be arranged in column-first order. However, the present disclosure is not limited thereto. The encoder/decoder may arrange two-dimensional blocks in the form of a one-dimensional array using various methods in addition to the lexicographic order.

In the present disclosure, a layered Givens transform may be applied to a given N×N transform. In general, a non-separable transform has high compression performance compared to a separable transform, but has a difficult fast implementation and requires high computational complexity. Accordingly, embodiments of the present disclosure are described based on a case where a target transform is a non-separable transform, but the present disclosure is not limited thereto. That is, a layered Givens transform may be applied to a separable transform and may be applied to a non-separable transform.

A general non-separable transform H applicable to an N×N block may be represented as an N²×N² matrix. A method proposed in the present disclosure may be used to approximate a non-orthogonal transform, but it is assumed that a target transform H satisfies orthonormal, that is, Equation 1 below, for convenience of description.

H^{T}H=I, [Equation 1]

In this case, HT indicates a transpose matrix of H, and I indicates an identity matrix of N²×N². Furthermore, an N²×N² permutation matrix P is an orthonormal matrix and satisfies Equation 2.

P^{T}P=I, [Equation 2]

Each row of P may include a single element not 0. When a data vector x is given, a vector y satisfying y=P*x may be obtained by shuffling the elements of the vector x.

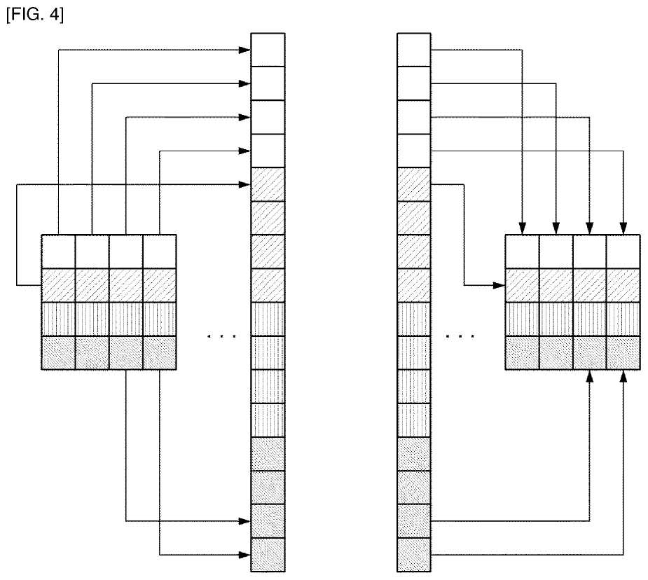

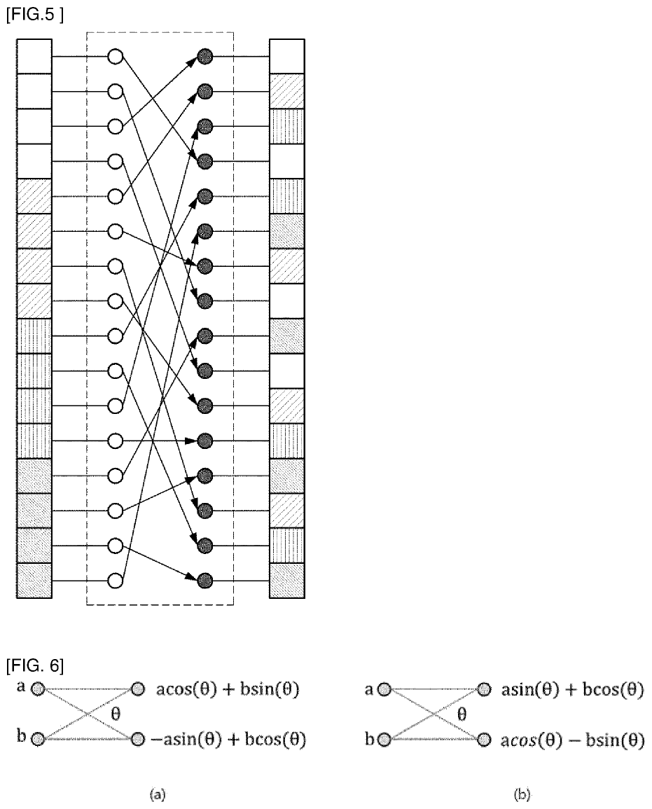

FIG. 5 is an embodiment to which the present disclosure is applied and is a diagram illustrating an example in which a permutation matrix is applied.

The encoder/decoder may shuffle data vectors by applying a permutation matrix as shown in FIG. 5. Subsequent computation can be efficiently performed by performing such shuffling. For example, non-zero coefficients may be concentrated on a specific area through shuffling.

The present disclosure proposes a method of finding a layered Givens transform G(N²×N²) approximated to H when the target transform H is given. G may be represented like Equation 3.

G=G_{M}G_{M-1} . . . G₁P₀ [Equation 3]

In this case, Gᵢ(N²×N²) (wherein i=1, 2, . . . , M) is a Givens rotation layer (or rotation layer, rotation matrix), and P₀(N²×N²) is a permutation layer (or permutation matrix). An integer M may have a given value, for example, 1, 2, 5, 10, log N, N. Gᵢ may be represented like Equation 4.

$${G}_{i} = {P}_{i}^{T} [ \begin{matrix}{T}_{i , 1} & & 0 & … & 0 \\ 0 & & {T}_{i , 2} & & \\ & & & & \\ & ⋮ & & ⋱ & \\ & 0 & & & {T}_{i , \frac{{N}^{2}}{2}}\end{matrix} ] {P}_{i} \qquad [ Equation 4 ]$$

In this case, Pᵢ(N²×N²) is a permutation matrix, and T_{(i,j)} is a pairwise rotation matrix (i.e., Givens rotation matrix). That is, the Givens rotation layer Gᵢ may be configured with a combination of the permutation matrix and the rotation matrix. T_{(i,j)} is described based on the following drawing.

FIG. 6 is an embodiment to which the present disclosure is applied and is a diagram illustrating an example in which a rotation matrix is applied.

Referring to FIG. 6(a), the rotation matrix T_{(i,j)} may be represented like Equation 5.

$${T}_{i , j} = [ \begin{matrix}cos ( {θ}_{i , j} ) & sin ( {θ}_{i , j} ) \\ - s in ( {θ}_{i , j} ) & cos ( {θ}_{i , j} )\end{matrix} ] \qquad [ Equation 5 ]$$

Referring to FIG. 6(b), in an embodiment of the present disclosure, T_{(i,j)}, such as Equation 6, may be taken into consideration in order to permit reflection along with rotation (i.e., rotation plus reflection). That is, in an embodiment of the present disclosure, T_{(i,j)} may form pairwise rotation and rotation plus reflection.

$${T}_{i , j} = [ \begin{matrix}sin ( {θ}_{i , j} ) & cos ( {θ}_{i , j} ) \\ cos ( {θ}_{i , j} ) & - s in ( {θ}_{i , j} )\end{matrix} ] \qquad [ Equation 6 ]$$

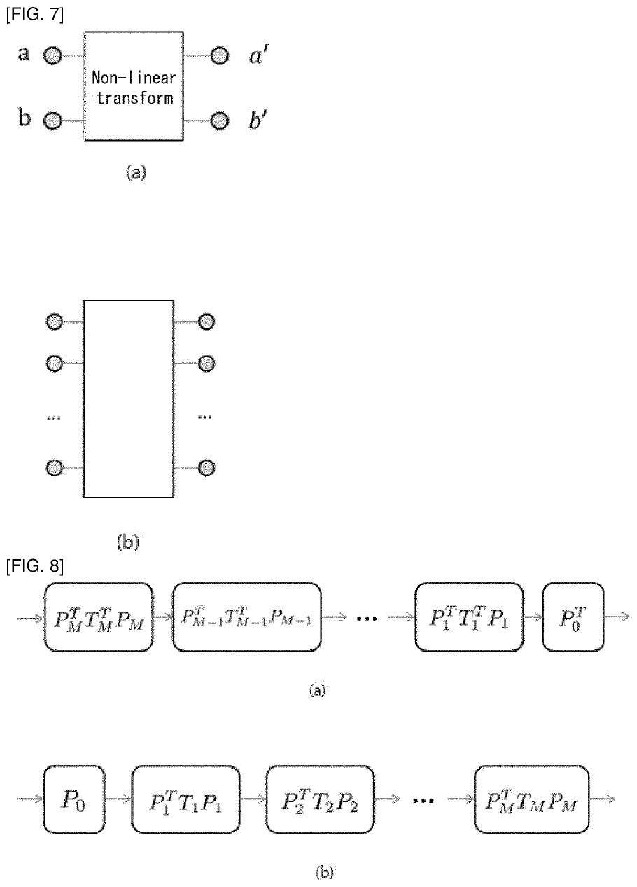

FIG. 7 is a diagram illustrating an example of a transform to which the present disclosure is applied.

In an embodiment of the present disclosure, as shown in FIG. 7(a), T_{(i,j)} may be configured as a general two-dimensional non-linear transform that receives two inputs and outputs two outputs.

Furthermore, in an embodiment of the present disclosure, as shown in FIG. 7(b), Too may be configured as a linear transform or non-linear transform having two or more dimensions.

Furthermore, as shown in FIG. 7, the LGT of the present disclosure may include a linear transform or non-linear transform of a two-dimensional or multi-dimension.

If Equation 5 or Equation 6 is used, the rotation matrix Tᵢ may be represented like Equation 7.

$${T}_{i} = [ \begin{matrix}{T}_{i , 1} & & 0 & … & 0 \\ 0 & & {T}_{i , 2} & & \\ & & & & \\ & ⋮ & & ⋱ & \\ & 0 & & & {T}_{i , \frac{{N}^{2}}{2}}\end{matrix} ] \qquad [ Equation 7 ]$$

A forward general transform (i.e., target transform H) may obtain a transform coefficient c_{general} using Equation 8 with respect to the data vector x.

c_{general}=H^{T}x [Equation 8]

Meanwhile, the LGT may obtain an LGT transform coefficient c_{LGT} using Equation 9.

c_{LGT}=G^{T}x=P₀^{T}G₁^{T} . . . G_{M}^{T}x [Equation 9]

An inverse transform of the transform coefficient generated by Equation 8 and Equation 9 may be performed by Equation 10.

x=Hc_{general}

x=Gc_{lGT}=G_{M} . . . G₁P₀c_{lGT} [Equation 10]

FIG. 8 is an embodiment to which the present disclosure is applied and is a diagram illustrating a method of applying forward and backward layered Givens transforms.

Referring to FIG. 8(a), the encoder may obtain an LGT transform coefficient by applying a forward LGT transform. Specifically, the encoder may obtain an LGT transform coefficient by sequentially applying a rotation layer and a permutation layer to input data x, as shown in FIG. 8(a).

Referring to FIG. 8(b), the encoder/decoder may reconstruct x by applying a backward LGT transform to the LGT transform coefficient. Specifically, the decoder may reconstruct (or obtain) x by sequentially applying a permutation layer and a rotation layer to the LGT transform coefficient, as shown in FIG. 8(b).

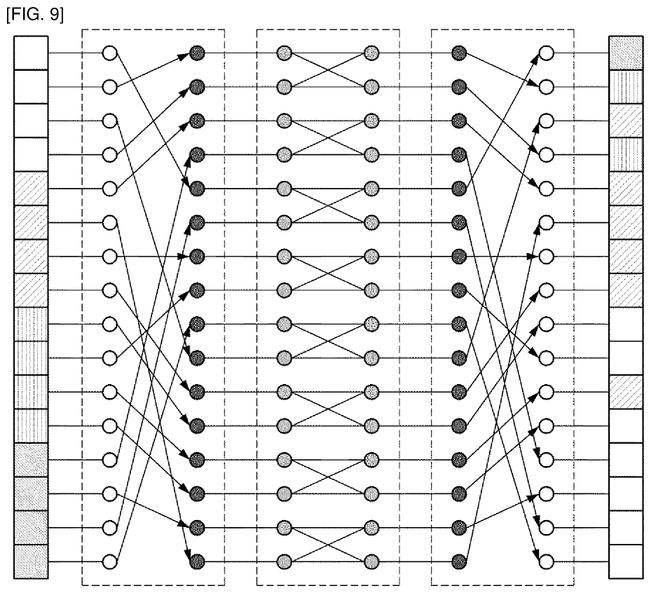

FIG. 9 is an embodiment to which the present disclosure is applied and is a diagram illustrating a method of applying a rotation layer.

Referring to FIG. 9, a Givens rotation layer Gᵢ may be configured with a combination of a permutation matrix and a rotation matrix. The encoder/decoder may apply the permutation matrix in order to efficiently apply pairwise rotation. The encoder/decoder may apply the rotation matrix to shuffled data and then reversely shuffle the shuffled data.

In one embodiment of the present disclosure, target transform H may be KLT, Sparse Orthonormal Transform (SOT), curvelet transform, contourlet transform, complex wavelet transform, or (Non Separable Secondary Transform (NSST).

Meanwhile, in another embodiment, in configuring the LGT, Equation 11 below may be used instead of Equation 3 above.

G=QG_{M}G_{M-1} . . . G₁P₀=QGᵢₙₜP, where P=P₀ and Gᵢₙₜ=G_{M}G_{M-1} . . . G₁ [Equation 11]

Referring to Equation 11, after Givens rotation layer G_int (int=1, 2, . . . , M), a permutation matrix (or permutation layer) may be additionally applied. In other words, in a first layer (or step) before G_int, a permutation matrix P may be applied and in a last layer (or step) after G_int, a permutation matrix Q may be applied. According to the embodiment, the application of the permutation matrix before and after the Givens rotation layer may further increase an approximation to the target transform.

As described above, the LGT may include one or more permutation layers and a plurality of Givens rotation layers. In the present disclosure, the permutation layer may be referred to as the permutation matrix. Further, the Givens rotation layer may be referred to as a rotation layer, a Givens rotation matrix, a rotation matrix, etc.

In Equations 3 and 11 described above, G represents inverse transform. When an input transform coefficient vector (N×1) is c, an output transform coefficient vector (N×1) x may be acquired using x=G*c. In Equations 3 and 11, P and Q represent a permutation layer (or permutation matrix) having a general N×N size. In addition, Pᵢ represents a permutation matrix for designing pairs to which a rotation matrix T_{i,1} is to be applied. For example, as shown in Equation 12 below, in an example of Pᵢ for a case of N=4, the rotation matrix T_{i,1} may be applied to first and fourth input pairs and a rotation matrix T_{i,2} may be applied to second and third input pairs.

$${P}_{i} = [ \begin{matrix}1 & 0 & 0 & 0 \\ 0 & 0 & 0 & 1 \\ 0 & 1 & 0 & 0 \\ 0 & 0 & 1 & 0\end{matrix} ] \qquad [ Equation 12 ]$$

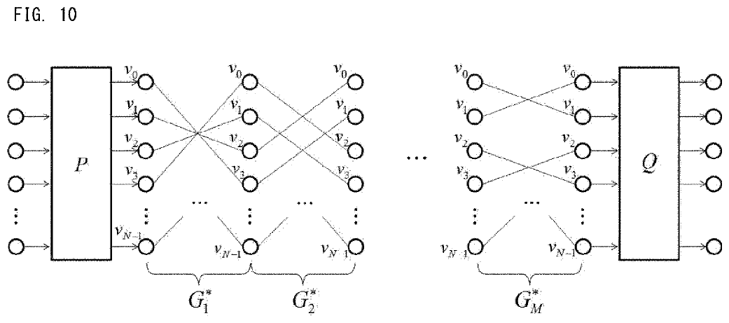

FIG. 10 is a diagram illustrating a calculation process of Layered Givens Transform according to one embodiment of the present disclosure.

Referring to FIG. 10, a process of calculating an output transform coefficient vector x by applying the LGT (x=G*c) is illustrated for each step. In FIG. 10, as described in Equation 11 above, the process will be described by assuming a case where the LGT includes a permutation layer (or permutation matrix) P and a permutation layer (or permutation matrix) Q.

Left nodes of the permutation layer P correspond to N×1 input data vectors and right nodes of the permutation layer Q correspond to N×1 output data vectors. In respective layers, since an input node pair is selected and rotation or reflection is applied and then an output node pair is positioned to the existing location again, nodes having the same height may be expressed as one node. In other words, among nodes other than the left nodes of P and the right nodes of Q, the respective nodes having the same height may be denoted as v₀, v₁, . . . , v_{N-1}.

Further, G₁, G₂*, . . . , G_{M}* is a graph indicating node connectivity for each Givens rotation layer. In Equation 3 or 11 described above, an asterisk superscript is attached to matrix G₁, G₂, . . . , G_{M} in order to distinguish G₁*, G₂*, . . . G_{M}* from the matrix G₁, G₂, . . . , G_{M}.

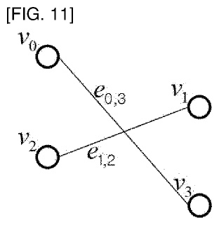

FIG. 11 is a diagram illustrating one example of an edge expression scheme according to one embodiment of the present disclosure.

Referring to FIG. 11, a case of N=4 is assumed. When nodes having the same height, which are denoted by v₁ are regarded as the same node as described above, G₁* of FIG. 10 above may be expressed by the graph shown in FIG. 11. In the present disclosure, an edge may indicate inter-node connection and the edge may be referred to as connection or pair. As illustrated in FIG. 11, each node may correspond to a vertex of the graph and as described in Embodiment 4 described below, each node may correspond to a hierarchically split group.

When the graph G* is expressed like G*=(V, E) the graph shown in FIG. 11 may be expressed as shown in Equation 13 below.

G₁*=(V,E₁), where V={v₀,v₁,v₂,v₃} and E₁={e_{0,3},e_{1,2}} [Equation 13]

In the present disclosure, it is assumed that the edges of the graph have no directivity. In other words, referring to Equation 13, a relationship of e_{0,3}=e_{3,0}, e_{1,2}=e_{2,1} may be established. The graph shown in FIG. 11 may be expressed with four vertexes and two edges.

Further, as one embodiment, unlike an example of FIG. 11 in which the edges of the graph handle all vertexes, the edge of the graph may not handle all vertexes. In this case, a vertex (or node) which is not connected by the edge may be bypassed. If E₁={e_{1,2}}, since v₀ and v₃ are not connected to any edge, when the calculation for the corresponding Givens rotation layer is performed, an input value may be bypassed to an output value without performing any calculation for v₀ and v₃.

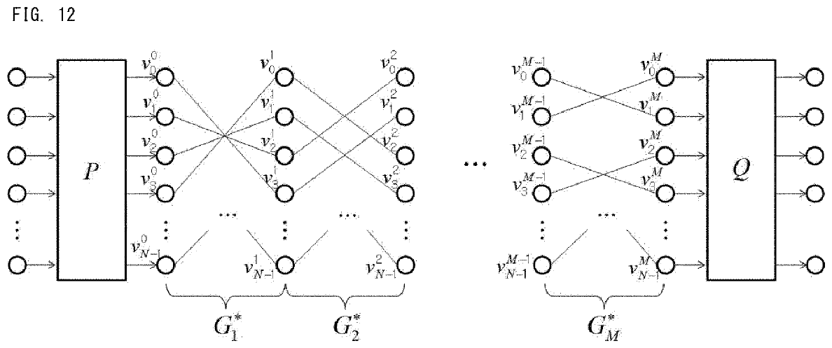

FIG. 12 is a diagram illustrating a calculation process of Layered Givens Transform according to one embodiment of the present disclosure.

Referring to FIG. 12, a process of calculating an output transform coefficient vector x by applying the LGT is illustrated for each step. In FIG. 12, as described in Equation 11 above, the process will be described by assuming a case where the LGT includes permutation layer P and permutation layer Q.

In order to specify which Givens rotation layer the nodes of FIG. 10 described above belong to, the respective nodes may be denoted by vᵢ′, i=0, 1, . . . , N−1, l=0, 1, . . . , M−1, M. In addition, a relationship between vᵢ^{l}s may be expressed as Equation 14 below.

$$[ \begin{matrix}{v}_{i}^{l} \\ {v}_{j}^{l}\end{matrix} ] = {A}_{i , j}^{l} \cdot [ \begin{matrix}{v}_{i}^{l 1} \\ {v}_{j}^{l 1}\end{matrix} ] , {e}_{i , j} ∈ {E}_{l} , \\ i , j = 1 , 2 , \text{...} , N - 1 , i \neq j , {A}_{i , j}^{l} ∈ {F}^{2 \times 2} \qquad [ Equation 14 ]$$

In Equation 14, field F may be a real-number set R or a complex number set C. Further, A_{i,j}^{l} represents a rotation matrix of performing rotation or reflection. A_{i,j}^{l} may be expressed using one parameter as shown in Equation 15 below.

$${A}_{i , j}^{l} = [ \begin{matrix}cos ( {θ}_{i , j}^{l} ) & sin ( {θ}_{i , j}^{l} ) \\ - s in ( {θ}_{i , j}^{l} ) & cos ( {θ}_{i , j}^{l} )\end{matrix} ] or \\ {A}_{i , j}^{l} = [ \begin{matrix}sin ( {θ}_{i , j}^{l} ) & cos ( {θ}_{i , j}^{l} ) \\ cos ( {θ}_{i , j}^{l} ) & - s in ( {θ}_{i , j}^{l} )\end{matrix} ] \qquad [ Equation 15 ]$$

If A_{i,j}^{l} is an arbitrary matrix other than a rotation or reflection matrix, A_{i,j}^{l} may be described using at least one parameter (e.g., four matrix elements).

In order to perform the LGT in the encoder and the decoder, both the encoder and the decoder should store information (alternatively, information for describing the LGT) related to the LGT or all or some related information should be transmitted from the encoder to the decoder. For example, information P and Q on the permutation layer may include edge information (e.g., E₁, E₂, . . . E_{M}), θ_{i,j}^{l} applied to each pair, and/or a flag for distinguishing rotation and reflection. In particular, the present disclosure proposes a method for efficiently describing the edge information among the information for describing the LGT.

### Embodiment 1

In one embodiment of the present disclosure, proposed is a method for more efficiently describing edges constituting a Givens rotation layer when a plurality of edge sets are predefined. As one embodiment, an edge set group Γ_{E} constituted by the plurality of predefined edge sets may be shown as Equation 16 below.

Γ_{E}={E₀^{t},E₁^{t}, . . . ,E_{P-1}^{t}} [Equation 16]

Referring to Equation 16, Γ_{E} may be constituted by a total of P predefined edge sets. For example, in applying Non-Separable Secondary Transform (NSST), all edges e_{j,j+s} for the Givens rotation layer constituting the NSST may be determined based on a routine of Table 1 below.

TABLE 1

for r = 0 : (round# − 1 )

for d = 0 : ( depth# − 1 )

s = 2^{d}
for i = 0 : (rotation# − 1 )

j = i + (i & (−s))

In Table 1, round # represents the number of all rounds and the round represents a layer group including one or more Givens rotation layers. depth # represents the number of Givens rotation layers which belong to one round and rotation # indicates the number of Givens rotations (i.e., rotation matrices) constituting one Givens rotation layer. In other words, M and N values in FIG. 10 described above may satisfy a relational equation of M=round #×depth # and N=2×rotation #. An edge e_{j,j+s} for a j value calculated according to the routine of Table 1 may be included in the corresponding edge set.

As one embodiment, in the case of NSST applied to 4×4 blocks, a total of four edge sets shown in Equation 17 below may be determined according to the routine of Table 1 described above.

E₀^{t}={e_{0,1},e_{2,3},e_{4,5},e_{6,7},e_{8,9},e_{10,11},e_{12,13},e_{14,15}}

E₁^{t}={e_{0,2},e_{1,3},e_{4,6},e_{5,7},e_{8,10},e_{9,11},e_{12,14},e_{13,15}}

E₂^{t}={e_{0,4},e_{1,5},e_{2,6},e_{3,7},e_{8,12},e_{9,13},e_{10,14},e_{11,15}}

E₃^{t}={e_{0,3},e_{1,9},e_{2,10},e_{3,11},e_{4,12},e_{5,13},e_{6,14},e_{7,15}}

Γ_{E}={E₀^{t},E₁^{t},E₂^{t},E₃^{t}} [Equation 17]

Further, the NSST applied to the 4×4 blocks may include a total of eight Givens rotation layers. Eᵢ∈Γ_{E}, i=1, 2, . . . , 8 representing the edge set for each Givens rotation layer may satisfy a relational equation of Equation 18 below.

E₁=E₀^{t},E₂=E₁^{t},E₃=E₂^{t},E₄=E₃^{t},E₅=E₀^{t},E₆=E₁^{t},E₇=E₂^{t},E₈=E₃^{t} [Equation 18]

If Eᵢ=E_{α}^{t}, i=1, 2, . . . , M, αᵢ∈{0, 1, . . . , P−1} is denoted, all edge sets Eᵢ of the Givens rotation layer may be expressed as (α₁, α₂, . . . , α_{M}). Equation 18 may be shown as Equation 19 so that each edge set corresponds to an edge set in Γ_{E}.

(α₁,α₂,α₃,α₄,α₅,α₆,α₇,α₈)=(0,1,2,3,0,1,2,3) [Equation 19]

Various values may be allocated to (α₁, α₂, . . . , α_{M}) based on given Γ_{E}. For example, since |Γ_{E}|=P, the number of all allocable cases may be P^{M}. On the contrary, when variables of Table 1 described above are applied to the NSST, a relational equation of α_{r-depth #)+d}=d is satisfied. In other words, the conventional NSST is disadvantageous in that all edge sets of the Givens rotation layer are allocated to only one case based on given Γ_{E}. Accordingly, in one embodiment of the present disclosure, proposed are various edge set allocating methods shown in Equation 20 or 21 below based on a given edge set group in addition to the limited allocation method in the conventional NSST.

αᵢ=f(i), i=1,2, . . . ,M, f:Z→{0,1, . . . ,P−1} [Equation 20]

Referring to Equation 20, the encoder/decoder may determine the edge set of each given rotation layer among a given edge set group Γ_{E} by using a predetermined specific function. As the specific function, various functions may be configured. For example, the encoder/decoder may determine the edge set of the Givens rotation layer included in the LGT in the edge set group Γ_{E} like an example of Equation 21 below.

α_{r-(round #)+d}=(depth #)−1−d

αᵢ=(i−1)mod P

αᵢ=(i−1)>>r [Equation 21]

Here, mod represents an operation for obtaining a remainder. In other words, the encoder/decoder may correspond the edge set corresponding to the remainder obtained by dividing (i−1) by P to the edge set of the Givens rotation layer in a second equation of Equation 21. In addition, >> represents a right shift operation.

### Embodiment 2

In one embodiment, proposed is a method for allocating an index per edge set or edge set group and describing a Givens rotation layer constituting LGT based on the allocated index. The encoder/decoder may designate each αᵢ representing the edge set of the Givens rotation layer as the index, or may group a predetermined number of αᵢ and designate a combination (or edge set group) of edge sets Eⱼ^{t} which may be mapped to each group as the index. In this case, the index may be stored as a format such as array, table, etc., similarly in the encoder and the decoder and signaled from the encoder to the decoder.

When Γ_{E} satisfies 2^{k-1}<|Γ_{E}|=P≤2^{k} and each αᵢ is designated as the index, αᵢ may be expressed as a binary number of k bits. Accordingly, in this case, k*M bits are required in order to store or signal αᵢ for M Givens rotation layers. Of course, when all edge set groups Γ_{E} permitted for the Givens rotation layer are differently configured, since the number |Γ_{E}| of constituent elements varies depending on Γ_{E}, the number of bits required for designating the index for each αᵢ may vary.

If Γ_{E} permitted for the Givens rotation layer is limited to include only meaningful elements (i.e., a relative small number of specific edge sets), since the number of bits required for allocating the index may be minimized, (α₁, α₂, . . . , α_{M}) may be expressed only with data even smaller than k*M bits described above. In this case, both the encoder and the decoder should similarly know which Γ_{E} set is to be used for each Givens rotation layer.

Hereinafter, 4×4 NSST will be described as an example. However, the present disclosure is not limited thereto and may be applied to another target transform by the same method. In the case of the 4×4 NSST, when Γ_{E} is given as shown in Equation 17 described above, αᵢ may be expressed as a 2-bit index. In addition, bit allocation to αᵢ in Equation 19 described above may be expressed as shown in Equation 22. Here, 0b which is a prefix corresponds to a binary number (or binary bit string).

(α₁,α₂,α₃,α₄,α₅,α₆,α₇,α₈)=(0b00,0b01,0b10,0b11,0b00,0b01,0b10,0b11) [Equation 22]

If the 4×4 NSST determined as shown in Equation 17 is modified, an arbitrary 2-bit value may be configured to be allocated to each αᵢ value. In this case, information of 2*8 bits is required to be stored or signaled.

As one embodiment, the encoder/decoder may group αᵢ and allocate an index indicating an edge set pattern used in each group. Here, the edge set pattern represents an order of a plurality of edge sets included in each group.

For example, in the case of NSST grouped per round, an r-th round may be described as α_{r-(depth #)}, α_{r-(depth #)+1}, . . . , α_{r-(depth #)+(depth #)-1} as shown in Table 1 above. In this case, the index may be allocated to an r-th group (or round) r=0, 1, . . . , (round #)−1) for the NSST as shown in Equation 23.

(α_{r-(depth #)},α_{r-(depth #)+1}, . . . ,α_{r-(depth #)+(depth #)-1)}=(0,1, . . . ,(depth #)-1) [Equation 23]

Referring to Equation 23, the maximum number of cases for a tuple (or edge set group) constituted by (depth #) elements like (α_{r (depth #)}, α_{r-(depth #)+1}, . . . α_{r-(depth #)+(depth #)-1)} is (2^{┌log}^{₂}^{(depth #)┐})^{(depth #)}. According a pattern for the corresponding tuple may be designated as maximum ┌log₂(depth #┐·(depth #) bits and if the number of permitted patterns is limited to Q, the pattern may be designated as ┌log₂ Q┐ bits.

For example, in the case of the 4×4 NSST, an αᵢ pattern for one round may be configured as shown in Equation 24 below.

(αᵣ₋₄,αᵣ₋₄₊₁, . . . ,αᵣ₋₄₊₃)=(0,1,2,3) [Equation 24]

Unlike NSST using only one pattern, the encoder/decoder may designate which pattern is to be used by allocating 2 bits as the index for respective rounds of (3, 2, 1, 0), (2, 0, 3, 1), and (1, 3, 0, 2) in addition to (0, 1, 2, 3). In other words, according to one embodiment of the present disclosure, when all edge sets are predefined, a plurality of patterns which may be applied to the layer group including one or more Givens rotation layers are designated as the index to diversify LGT which is usable as relative small data.

### Embodiment 3

In one embodiment of the present disclosure, the encoder/decoder may store the edge information in the Givens rotation layer of the LGT or the encoder may signal the stored edge information to the decoder. First, as one embodiment, the encoder/decoder may designate (or allocate) an index indicating a corresponding vertex for each vertex (or node) of each Givens rotation layer.

For example, when the edge set of the Givens rotation layer is configured by E₁={e_{0,3},e_{1,2}} as illustrated in FIG. 11 described above, the encoder/decoder may allocate a binary index as shown in Equation 25 below. Referring to Equation 25, βᵢ^{l} represents a binary index for a vertex connected to an i-th vertex of an l-th Givens rotation layer. In addition, an operator represents concatenation of bit strings.

β₀¹=3=0b11,β₁¹=2=0b10,β₂¹=1=0b01,β₃¹=0=0b00,β₀¹·β₁¹·β₂¹·β₃¹=0b11100100 [Equation 25]

However, the method shown in Equation 25 has a disadvantage in that the index is allocated to redundant information. As described above, since there is no directivity for each edge and there is only pair information, β₀¹ and β₃¹ are duplicated with each other in that β₀¹ and β₃¹ include the same information and the same is applied even in the case of β₁¹ and β₂¹ in Equation 25. Accordingly, methods that may reduce a data amount allocated to the index will be described below.

In one embodiment, the encoder/decoder may generate a list (hereinafter, may be referred to as an edge list or a pair list) for all pairs (or edges) which are available and determine the index in the list for each pair. For example, when there are four vertexes as illustrated in FIG. 11 described above, the encoder/decoder may generate the list as shown in Table 2 below. Here, Nil represents that no vertex is formed.

TABLE 2

| Index | Pair |
|---|---|
| 0 | Nil |
| 1 | (0, 1) |
| 2 | (0, 2) |
| 3 | (0, 3) |
| 4 | (1, 2) |
| 5 | (1, 3) |
| 6 | (2, 3) |

When β^{l}(e_{i,j}) is a binary index in Table 2 for e_{i,j} in the l-th Givens rotation layer, an example of the index allocation to the edge set (i.e., E₁={e_{0,3},e_{1,2}}) of FIG. 12 described above is shown in Equation 26 below.

β¹(e_{0,3})=3=0b011,β¹(e_{1,2})=4=0b100,β¹(e_{0,3})·β¹(e_{1,2})=0b011100 [Equation 26]

Referring to FIG. 26, since Table 2 is constituted by a total of 7 cases, a case where 3 bits are allocated for each edge is assumed. On the contrary, an index value may be generated using a truncated binary code in order to further reduce the quantity of bits. Since E₁{e_{1,2}}, when the calculation is not performed for v₀ and v₃ and an input is bypassed to an output, the index indicating Nil may be connected before or after as shown in Equation 27 below.

β¹(e_{1,2})=4=0b100,β¹(e_{1,2})·Nil=0b100000 [Equation 27]

In another embodiment, the encoder/decoder may limit the vertexes which may be connected for each vertex and allocate the index for each index so as to handle all pairs which are available within a limited range in order to reduce an information amount used for the index. For example, as described in FIG. 11 above, when four vertexes are provided, the vertex corresponding for each vertex may be indicated (or divided) as a binary code.

TABLE 3

| Vertex | Connected vertex | Binary index |
|---|---|---|
| 0 | None | 00 |
| | 1 | 01 |
| | 2 | 10 |
| | 3 | 11 |
| 1 | None | 0 |
| | 2 | 1 |
| 2 | None | 0 |
| | 3 | 1 |
| 3 | None | 0 |
| | 1 | 1 |

Referring to Table 3, v₀ may be configured to include v₁ as a connectable vertex, while v₁ may be configured not to include v₀ as the connectable vertex. Therefore, bits allocated to duplicated cases may be reduced. The encoder/decoder may allocate binary index 01 to v₀ and allocate binary index 0 (none) to v₁ if e_{0,1} is included in the edge set.

For example, if there is no directivity of edges for a graph constituted by N vertexes, the number of cases for available edges is

$${N}_{e} = \frac{N ( N - 1 )}{2} .$$

After Nₑ pairs (or edges) are distributively allocated to N vertexes, if the index is allocated to each case, all of Nₑ pairs may be described. Table 3 described above illustrates one example of distributing all of Nₑ pairs without duplicated information. When an index (or index code) granted to an i-th vertex is denoted by βᵢ^{l} for the l-th Givens rotation layer, E₁={e_{0,3}, e_{1,2}} for FIG. 11 described above may be expressed as Equation 28 below.

β₀¹=3=0b11,β₁¹=1=0b1,β₂¹=0=0b0,β₃¹=0=0b0,β₀¹·β₁¹·β₃¹=0b11100 [Equation 28]

If E₁={e_{1,2}}, the calculation is not performed for v₀ and v₃ and v₀ and v₃ are bypassed to the output and in this case, each index may be determined as shown in Equation 29 below.

β₀¹=0=0b00,β₁¹=1=0b1,β₂¹=0=0b0,β₃¹=0=0b0,β₀¹·β₁¹·β₂¹·β₃¹=0b00100 [Equation 29]

When Equations 28 and 29 described above are compared with Equation 27, it may be verified that the number of bits of the index information is reduced by 1 bit in order to express the edge set of the Givens rotation layer, and as a result, an information amount required for storing the index or an information amount required for signaling may be reduced.

Specifically, when the total number of vertexes is N=2n, since

$${N}_{e} = \frac{N ( N - 1 )}{2} = {2}^{n - 1} \cdot ( {2}^{n} - 1 ) = ( {2}^{n} - 1 ) + ( {2}^{n} - 1 ) \cdot ( {2}^{n - 1} - 1 ) ,$$

the encoder/decoder allocates indexes for connection to (2ⁿ−1) vertexes for a 0-th vertex (in this case, as shown in Table 3, when None is allocated as index 0, the vertex may be expressed as a total of n bits) and allocates indexes for connection to (2ⁿ⁻¹−1) vertexes for other vertexes (in this case, as shown in Table 3, when None is allocated as index 0, the vertex may be expressed as n−1 bits) to handle all edges. Table 4 below shows a method for allocating the index configured by the aforementioned scheme in the case of N=16.

TABLE 4

| Vertex | Connected vertex | Binary index |
|---|---|---|
| 0 | None | 0000 |
| | 1 | 0001 |
| | 2 | 0010 |
| | . . . | . . . |
| | 15 | 1111 |
| 1 | None | 000 |
| | 2 | 001 |
| | 3 | 010 |
| | 4 | 011 |
| | 5 | 100 |
| | 6 | 101 |
| | 7 | 110 |
| | 8 | 111 |
| 2 | None | 000 |
| | 3 | 001 |
| | 4 | 010 |
| | 5 | 011 |
| | 6 | 100 |
| | 7 | 101 |
| | 8 | 110 |
| | 9 | 111 |
| . . . | . . . | . . . |

In another embodiment, the encoder/decoder may limit vertexes which are connectable for each vertex in order to reduce the information amount required for storing the index or the information amount required for signaling.

In the case of the conventional NSST, according to Table 1 described above, vertexes which may be connected to the i-th vertex over all Givens rotation layers are limited to (depth #) vertexes. In the embodiment, the encoder/decoder may select a specific vertex for every vertex using an index indicating the corresponding vertex among the vertexes connectable in the conventional NSST. In other words, the encoder/decoder may allocate a binary index value by assigning ┌log₂(depth #)┐ bits to the index indicating the specific vertex among (depth #) vertexes connectable to respective vertexes. Alternatively, the encoder/decoder may allocate the truncated binary code according to a (depth #) value.

Table 5 below shows an example of allocating the vertexes connected for each vertex and the indexes corresponding thereto by applying the scheme to the NSST applied to the 4×4 blocks.

TABLE 5

| Vertex | Connected vertex | Binary index |
|---|---|---|
| 0 | 1/2/4/8 | 00/01/10/11 |
| 1 | 0/3/5/9 | 00/01/10/11 |
| 2 | 0/3/6/10 | 00/01/10/11 |
| 3 | 1/2/7/11 | 00/01/10/11 |
| 4 | 0/5/6/12 | 00/01/10/11 |
| 5 | 1/4/7/13 | 00/01/10/11 |
| 6 | 2/4/7/14 | 00/01/10/11 |
| 7 | 3/5/6/15 | 00/01/10/11 |
| 8 | 0/9/10/12 | 00/01/10/11 |
| 9 | 1/8/11/13 | 00/01/10/11 |
| 10 | 2/8/11/14 | 00/01/10/11 |
| 11 | 3/9/10/15 | 00/01/10/11 |
| 12 | 4/8/13/14 | 00/01/10/11 |
| 13 | 5/9/12/15 | 00/01/10/11 |
| 14 | 6/10/12/15 | 00/01/10/11 |
| 15 | 7/11/13/14 | 00/01/10/11 |

Referring to Table 5, the encoder/decoder may generate the list so that edges are generated twice at each vertex. According to the embodiment, the encoder/decoder may be configured to handle (or consider) all edges which are available by evenly distributing the edges to all vertexes while removing duplicated edges as shown in Table 3 or 4.

Further, as one example, the encoder/decoder may reduce the number of vertexes which may be connected to each vertex by removing the duplicated edges in Table 5 and add the case of None to each vertex as shown in Table 3 or 4. In this case, three cases are allocated to each vertex and fewer bits are allocated to three cases to reduce the information amount compared with designing the 2-bit index for all cases as shown in Table 5. For example, the encoder/decoder may allocate codes of 0, 10, and 11 to three cases.

In Table 5, distances up to the vertexes which may be connected to the respective vertexes are 1, 2, 4, and 8, respectively. In other words, the encoder/decoder may configure the vertexes connected from the respective vertexes to be distributed from near vertexes up to far vertexes.

Further, in one embodiment, the encoder/decoder may apply different index allocation schemes for respective Givens rotation layers. For example, the encoder/decoder may configure the table so as to connect near vertexes in an odd-numbered Givens rotation layer and far vertexes in an even-numbered Givens rotation layer.

For example, the encoder/decoder may configure the table so as to connect only vertexes having distances of 1 and 2 in the odd-numbered Givens rotation layer and only vertexes having distances of 4 and 8 in the even-numbered Givens rotation layer. In this case, the encoder/decoder may designate the index by using the table of Table 6 below in the odd-numbered Givens rotation layer and the table of Table 7 in the even-numbered Givens rotation layer.

TABLE 6

| Vertex | Connected vertex | Binary index |
|---|---|---|
| 0 | 1/2 | 0/1 |
| 1 | 0/3 | 0/1 |
| 2 | 0/3 | 0/1 |
| 3 | 1/2 | 0/1 |
| 4 | 5/6 | 0/1 |
| 5 | 4/7 | 0/1 |
| 6 | 4/7 | 0/1 |
| 7 | 5/6 | 0/1 |
| 8 | 9/10 | 0/1 |
| 9 | 8/11 | 0/1 |
| 10 | 8/11 | 0/1 |
| 11 | 9/10 | 0/1 |
| 12 | 13/14 | 0/1 |
| 13 | 12/15 | 0/1 |
| 14 | 12/15 | 0/1 |
| 15 | 13/14 | 0/1 |

TABLE 7

| Vertex | Connected vertex | Binary index |
|---|---|---|
| 0 | 4/8 | 0/1 |
| 1 | 5/9 | 0/1 |
| 2 | 6/10 | 0/1 |
| 3 | 7/11 | 0/1 |
| 4 | 0/12 | 0/1 |
| 5 | 1/13 | 0/1 |
| 6 | 2/14 | 0/1 |
| 7 | 3/15 | 0/1 |
| 8 | 0/12 | 0/1 |
| 9 | 1/13 | 0/1 |
| 10 | 2/14 | 0/1 |
| 11 | 3/15 | 0/1 |
| 12 | 4/8 | 0/1 |
| 13 | 5/9 | 0/1 |
| 14 | 6/10 | 0/1 |
| 15 | 7/11 | 0/1 |

Referring to Tables 6 and 7, the encoder/decoder may generate the table so that edges are duplicated twice at each vertex. Accordingly, the number of vertexes in Tables 6 and 7 is reduced to the number of vertexes in Tables 8 and 9 to reduce the information amount required for the index by half. Specifically, in each of Tables 6 and 7, 16 bits should be stored or signaled, but in each of Tables 8 and 9, only 8 bits may be used and stored or signaled.

TABLE 8

| Vertex | Connected vertex | Binary index |
|---|---|---|
| 0 | 1/2 | 0/1 |
| 3 | 1/2 | 0/1 |
| 4 | 5/6 | 0/1 |
| 7 | 5/6 | 0/1 |
| 8 | 9/10 | 0/1 |
| 11 | 9/10 | 0/1 |
| 12 | 13/14 | 0/1 |
| 15 | 13/14 | 0/1 |

TABLE 9

| Vertex | Connected vertex | Binary index |
|---|---|---|
| 0 | 4/8 | 0/1 |
| 1 | 5/9 | 0/1 |
| 2 | 6/10 | 0/1 |
| 3 | 7/11 | 0/1 |
| 12 | 4/8 | 0/1 |
| 13 | 5/9 | 0/1 |
| 14 | 6/10 | 0/1 |
| 15 | 7/11 | 0/1 |

In Tables 5 and 9 described above, an example extended from the conventional NSST, which designates the vertexes connectable for each vertex by limiting inter-vertex connectivity of the Givens rotation layer of the NSST is described. As described above, the present disclosure is not limited to the inter-vertex connectivity of the Givens rotation layer of the conventional NSST. Further, as described above, the encoder/decoder may determine connectable vertexes at each vertex based on inter-vertex distance. For example, vertexes separated by a multiple of 3 are selected as the connectable vertexes, the encoder/decoder may configure 5, 8, 11, and 14-th vertexes as the connectable vertexes for a second vertex and allocate the index to the corresponding case.

### Embodiment 4

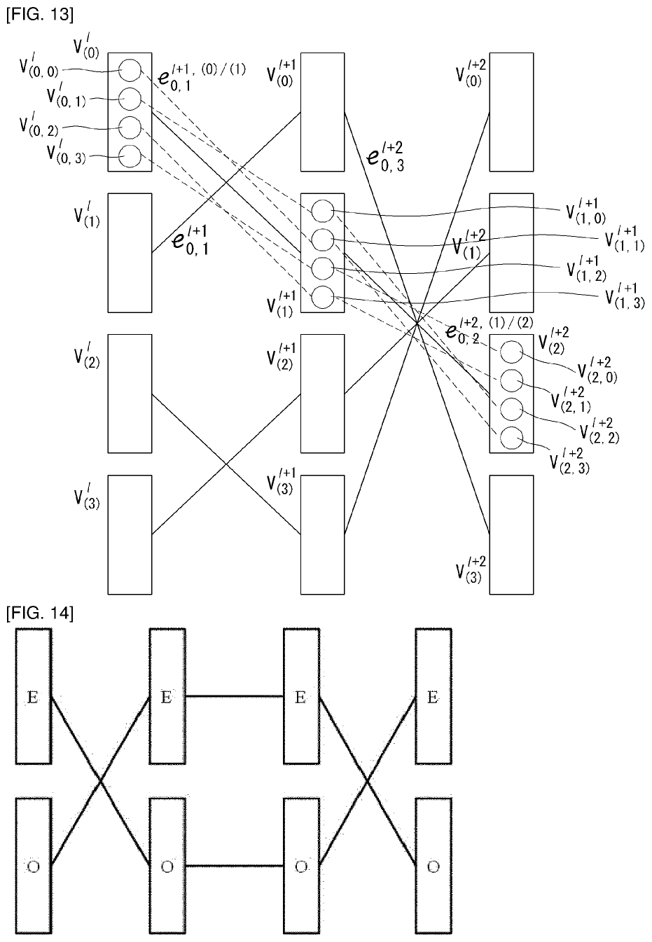

FIG. 13 is a diagram illustrating a method for hierarchically determining edge information of a Givens rotation layer according to one embodiment of the present disclosure.

In one embodiment of the present disclosure, the encoder/decoder may hierarchically mix and apply the methods of Embodiments 1 to 3 described above.

FIG. 13 illustrates two Givens rotation layers and in this case, it is assumed that each Givens rotation layer has 16 input/output nodes.

The encoder/decoder may split vertexes of two Givens rotation layers into first sub groups including a specific number of vertexes. In addition, the encoder/decoder determines connections between first sub groups and determines connection between the vertexes in the first sub group to finally determine the edge set of the Givens rotation layer.

FIG. 13 illustrates a case where grouping is performed only once so the group is constituted only by two levels of hierachy. But unlike this, the encoder/decoder may split the first sub group into second sub groups including a plurality of vertexes again. In addition, a connections between the second sub groups may be determined. In FIG. 13, v₍ᵢ_{₀}_{, i}_{₁}_{, . . . , i}_{_{d}}₎^{l} represents an i_{d}-th vertex of a group which is present in an 1-th vertex layer (i.e., an input node of an 1-th Givens rotation layer) and is hierarchically grouped d times and then generated.

In addition, eᵢ_{_{d}}_{, j}_{_{d}}^{l+1(i}^{₀}^{, i}^{₁}^{, . . . , i}^{_{d-1}}^{)/(j}^{₀}^{, j}^{₁}^{, . . . , j}^{_{d-1}}^{) is an edge included in an l+}1-th Givens rotation layer and represents a connection (or pair or edge) between an i_{d}-th vertex and a j_{d}-th vertex after being hierarchically grouped d times. i₀, i₁, . . . , i_{d} and j₀, j₁, . . . , j_{d} are indexes indicating the group or vertex in each level.

In this case, any one of the methods described in Embodiments 1 to 3 above may be applied to the connection in each level. For example, the encoder/decoder may use a fixed connection (or edge set) according to the conventional NSST scheme as the connection between the first sub groups constituted by four vertexes of FIG. 13 and store or signal the pair information in a table format according to the scheme described in Embodiment 3 for the connections between the vertexes in the first sub group.

FIG. 14 is a diagram illustrating a method for hierarchically determining edge information of a Givens rotation layer according to one embodiment of the present disclosure.

Referring to FIG. 14, the encoder/decoder may group all vertexes of the Givens rotation layer into vertexes having odd indexes and vertexes having even indexes. The vertexes having the even indexes may be denoted by v₀, v₂, v₄, . . . and the vertexes having the odd indexes may be denoted by v₁, v₃, v₅, . . . .

In addition, the encoder/decoder may first determine the inter-group connection (or edge) and then determine an inter-vertex connection in the group. Further, as described above, the encoder/decoder may split the vertexes into groups including a plurality of vertexes in the group and then determine the connections between the vertexes in the split group.

In one embodiment, the inter-group connection may be fixed for each Givens rotation layer and the inter-group connection may be configured to be selected through information of 1 bit. For example, when the index value is 0, the index value may indicate connections between groups including even vertexes and when the index value is 1, the index value may indicate connections between a group including even vertexes and a group including odd vertexes.

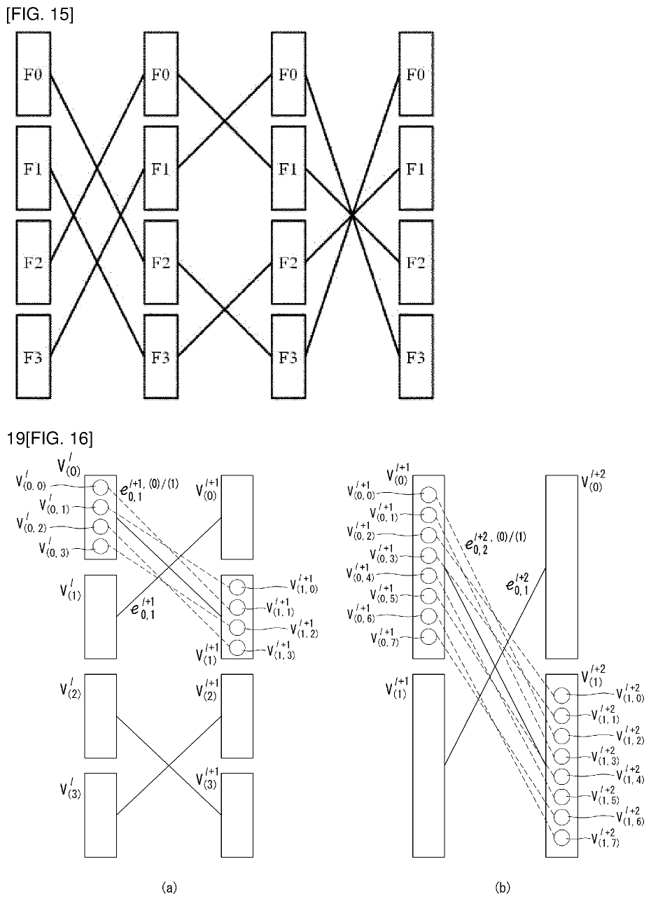

FIG. 15 is a diagram illustrating a method for hierarchically determining edge information of a Givens rotation layer according to one embodiment of the present disclosure.

Referring to FIG. 15, the encoder/decoder may group the vertexes into groups F0, F1, F2, and F3 including four vertexes based on a remainder acquired by dividing all vertexes of the Givens rotation layer by 4.

In addition, the encoder/decoder may first determine the inter-group connection (or edge) and then determine an inter-vertex connection in the group. Further, as described above, the encoder/decoder may split the vertexes into groups including a plurality of vertexes in the group and then determine the connection between the vertexes in the split group.

In one embodiment, the encoder/decoder may determine the inter-group connection by applying any one of the methods described in Embodiments 1 to 3 described above. For example, the encoder/decoder may allocate a 2-bit index indicating a group connected for each group and may allocate an index of a maximum of 4 bits indicating the total number of (i.e., 13 types) of available edges to each of the available edges.

FIG. 16 is a diagram illustrating a method for hierarchically determining edge information of a Givens rotation layer according to one embodiment of the present disclosure.

In FIGS. 13 to 15 above, it is assumed and described that the groups in the same level have the same size, but a configuration of the groups between the Givens rotation layers may be changed.

Referring to FIG. 16, the vertexes may be split into groups including four vertexes for the l+1-th given rotation layer and groups including eight vertexes for the l+2-th Givens rotation layer.

The encoder/decoder may determine the inter-group connection by applying any one of the methods described in Embodiments 1 to 3 described above. If the grouping scheme varies depending on the Givens rotation layer, the encoder/decoder may determine the grouping scheme for each Givens rotation layer using additional information regarding the grouping scheme. For example, when K grouping schemes are usable, the encoder/decoder may separately store or signal bit information for selecting any one of K grouping schemes.

### Embodiment 5

In one embodiment of the present disclosure, the encoder/decoder may store a flag indicating whether Givens rotation included in each Givens rotation layer is a rotation matrix having a rotation characteristic or a rotation matrix having a reflection characteristic or the encoder may signal the flag. Here, the rotation matrix having the rotation characteristic may be represented as shown in Equation 5 described above and the rotation matrix having the reflection characteristic may be represented as shown in Equation 6 described above. As one example, when the flag value is 0, the flag value may indicate rotation and when the flag value is 1, the flag value may indicate reflection.

Further, in addition to the rotation and the reflection, an arbitrary transform matrix may be used. For example, when two inputs and two outputs are provided, a 2×2 transform matrix may be used and when M inputs and M outputs are provided, an M×M transform matrix may be used.

In this case, the encoder/decoder may store bit information for selecting any one of all transform matrices which are usable or signal the bit information from the encoder to the decoder. Further, information on the arbitrary transform matrix may be prestored in the encoder and the decoder and signaled from the encoder to the decoder through a bitstream.

For example, the encoder/decoder may determine the LGT by additionally using the aforementioned flag in addition to the edge information and angular information for each Givens rotation layer by modifying the conventional NSST.

In one embodiment, the encoder/decoder may determine the edge sets of the Givens rotation layers constituting the LGT by applying the methods described in Embodiments 1 to 4 described above. By determining edge sets of the Givens rotation layers constituting the LGT, the encoder/decoder may determine pairs to which the Givens rotation is applied in the Givens rotation layers. In addition, the encoder/decoder may determine the rotation characteristic of the Givens rotation included in the Givens rotation layers based on the flag. In addition, the encoder/decoder may finally determine the Givens rotation layer of the LGT by determining a rotational angle θ of the Givens rotation included in each of the Givens rotation layers.

### Embodiment 6

In one embodiment of the present disclosure, the encoder/decoder may configure to bypass the vertex at an input side to the vertex at an output side without performing calculation for the vertex at the input side which is not matched through the edge. Through such a bypass configuration, the encoder/decoder may remarkably reduce a calculation amount due to the Givens rotation.

As one embodiment, the encoder/decoder may limit the maximum number of Givens rotations which may be included in one Givens rotation layer. For example, in FIG. 10, when N is 16, one Givens rotation layer may include a maximum of eight Givens rotations and in this case, the encoder/decoder may limit the maximum number of Givens rotations included in one Givens rotation layer to four. In this case, a required computation amount may be reduced by half by assuming that the same number of Givens rotation layers are provided.

Further, when it is assumed that the total number of Givens rotations is maintained as the same number, the number of Givens rotation layers may increase by reducing the number of Givens rotations included in one Givens rotation layer. Therefore, a latency required for outputting a total calculation result may increase, but coding performance according to application of the LGT may be further enhanced.

In this case, the Givens rotation may be the rotation matrix having the rotation or reflection characteristic described in FIGS. 5 and 6 and may be an arbitrary transform matrix. If information on the edges is described through the bit information like a case where the method in Embodiment 3 above is applied for each Givens rotation layer, the number of Givens rotations may be reduced for each Givens rotation layer. In this case, since the number of edges to be described through the bit information is reduced, a data required to be stored or signaled may be reduced.

### Embodiment 7

In one embodiment of the present disclosure, the encoder/decoder may determine a region to which a secondary transform is applied by splitting a block. In the present disclosure, the transform used for the secondary transform may be LGT or NSST. In one embodiment, the encoder/decoder may split the block into regions to which the LGT or NSST may be applied and then, determine the transform to be applied to the split region.

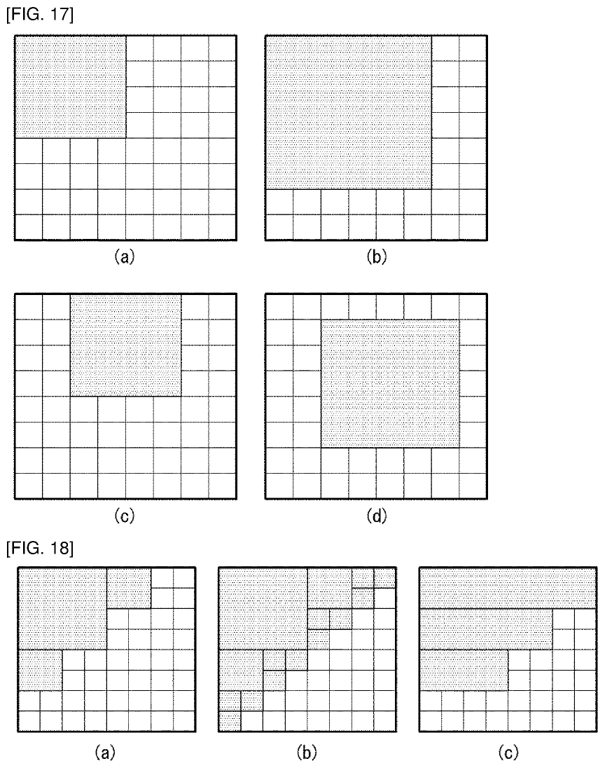

FIGS. 17 and 18 are diagrams illustrating application regions of a secondary transform according to one embodiment of the present disclosure.

Referring to FIG. 17, the encoder/decoder may determine regions having various sizes and locations to which the LGT or NSST is applied.

In FIGS. 17(a) and 17(b), the encoder/decoder may differently configure the sizes of the regions to which the secondary transform (i.e., LGT or NSST) is applied. In FIGS. 17(c) and 17(d), the encoder/decoder may configure a start location (or reference point) of the region to which the secondary transform is applied to another location other than a top-left location.

Referring to FIG. 18, the encoder/decoder may determine the region to which the secondary transform (e.g., LGT or NSST) is applied as illustrated in FIG. 18 except for a rectangular region unlike FIG. 17 described above. In this case, the encoder/decoder may configure the region to which the secondary transform is applied into regions to which unit LGT or unit NSST may be applied even when the corresponding region is not rectangular.

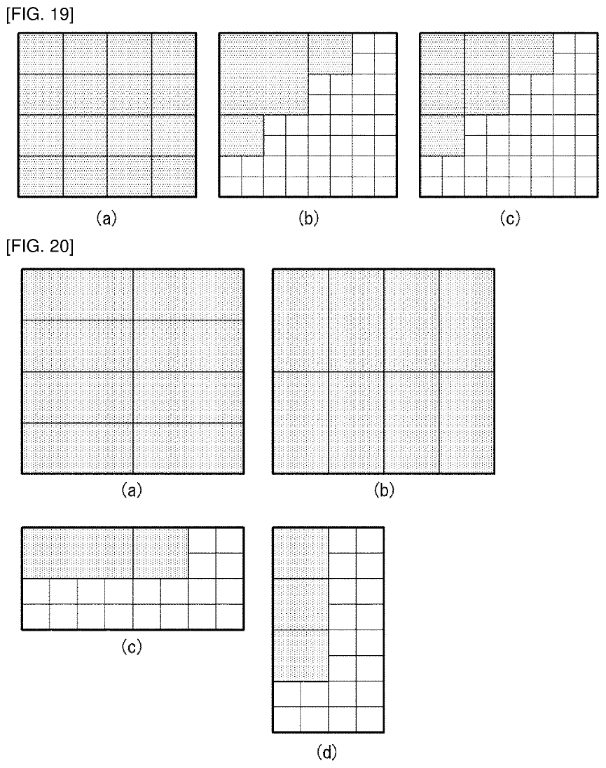

FIG. 19 is a diagram illustrating application regions of a secondary transform according to one embodiment of the present disclosure.

Referring to FIG. 19, the encoder/decoder may split the region to which the secondary transform is applied and determine transforms individually applied to the split regions.

Referring to FIG. 19(a), for the entire region to which the secondary transform is applied, the encoder/decoder may split a current block into blocks having a uniform size and apply the secondary transform to the split blocks. FIGS. 19(b) and 19(c) illustrate two examples in which the region illustrated in FIG. 18(a) described above is into regions to which the secondary transform is individually applied.

Specifically, the encoder/decoder may apply to the top-left region a secondary transform having horizontal and vertical lengths which are twice larger than a second transform applied to right and lower square regions. In addition, the encoder/decoder may split the corresponding region into regions having a uniform size and apply the secondary transform to the split regions.

Further, a shape of the region to which the secondary transform is applied need not particularly be rectangular. The reason is that when a non-separable transform is applied, all data (or pixels or coefficients) which are present in the corresponding region are transformed into 1-dimension vectors and then, the transform is applied to the 1-dimension vectors. For example, the encoder/decoder may apply the secondary transform to a triangular region including a plurality of regions as illustrated in FIG. 18(b).

FIG. 20 is a diagram illustrating application regions of a secondary transform according to one embodiment of the present disclosure.

Referring to FIG. 20, the region to which the secondary transform (e.g., LGT or NSST) is applied is split into non-square blocks, and the secondary transform may be applied in units of respective split blocks. The encoder/decoder may split the region into non-square blocks each of which is long in a horizontal direction or non-square blocks each of which is long in a vertical direction as illustrated in FIG. 20(a) or 20(b). In addition, when a current block is the non-square block, the encoder/decoder may split the current block into combinations of the non-square blocks and/or the square blocks and apply the secondary transform to the respective split regions.

In the embodiment described in FIGS. 19 and 20 above, the current block may be split into the blocks to which the secondary transform may be individually applied and then, a same transform may be applied to all blocks or different transforms may be applied to all blocks. As one embodiment, when the secondary transform is individually applied to the split blocks, the encoder/decoder may determine the applied secondary transform based on the location of the split block and the prediction mode.

As one example, in the case of FIG. 19(a), different transforms may be applied to all of 16 blocks. Alternatively, the blocks may be grouped and different transforms may be applied for respective groups.

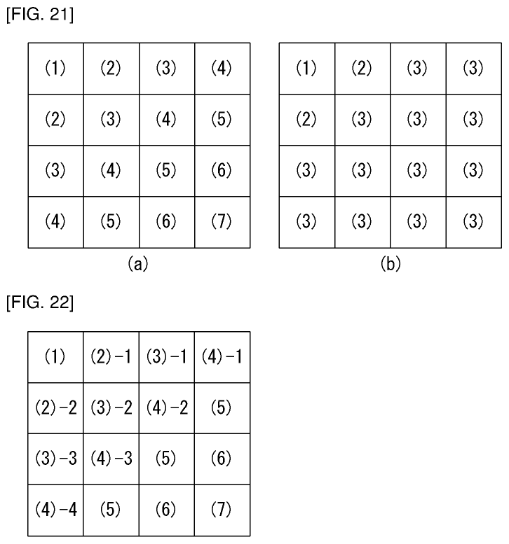

FIG. 21 is a diagram illustrating application regions of a secondary transform according to one embodiment of the present disclosure.

Referring to FIG. 21(a), the encoder/decoder may group the blocks based on a reverse diagonal direction and apply transforms for respective groups. In this case, as illustrated in FIG. 21(a), blocks to which the same number is assigned may be grouped as the same group.

Further, referring to FIG. 21(b), the encoder/decoder may group the blocks based on the reverse diagonal direction only in regions relatively closer to a top left side and classify all of the remaining regions into a same group and apply the same transform to the same group. In this case, as illustrated in FIG. 21(b), blocks to which the same number is assigned may be grouped as the same group.

FIG. 22 is a diagram illustrating application regions of a secondary transform according to one embodiment of the present disclosure.

Referring to FIG. 22, the encoder/decoder may apply a same transform to blocks which are symmetric based on a diagonal line. In a case that the non-separable transform such as the NSST is applied to each block, the encoder/decoder may configure transform data so as to transform the blocks which are symmetric based on the diagonal line in a column (or row) unit order not in the row (or column) unit order when transforming 2-dimensional input data into 1-dimensional input data.

For example, the encoder/decoder may perform 1-dimensional data transform for blocks (2)-1, (3)-1, (4)-1, and (4)-2 of FIG. 22 in the column (or row) unit order and perform 1-dimensional data transform for blocks (2)-2, (3)-3, (4)-3, and (4)-4 in the row (or column) unit order reversely thereto and then, apply a corresponding transform. The encoder/decoder may transform block (3)-2 of FIG. 22 into the 1-dimensional input data by selecting any one of the column or row order.

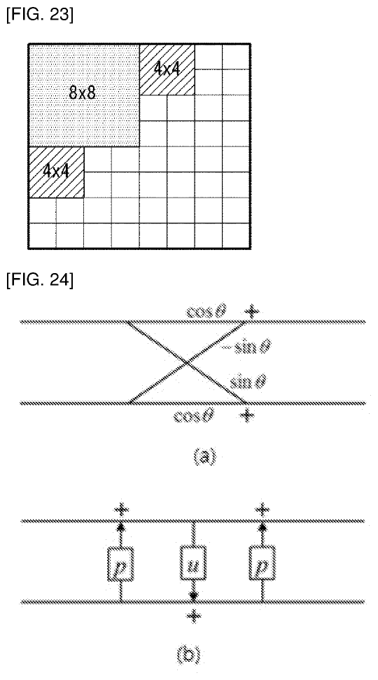

FIG. 23 is a diagram illustrating application regions of a secondary transform according to one embodiment of the present disclosure.

Referring to FIG. 23, the encoder/decoder may apply the secondary transform (e.g., LGT or NSST) to a top-left 8×8 region and right and lower 4×4 regions adjacent thereto.

In the conventional image encoding technology, when both a horizontal length and a vertical length of the current block are equal to or larger than 8, 8×8 NSST is applied only to the top-left 8×8 region and the top-left 8×8 region is split into 4×4 blocks and 4×4 NSST is applied to the split 4×4 blocks in the remaining cases. Further, when an NSST flag indicating whether to apply NSST is 1, an index indicating any one of transform sets (e.g., constituted by two or three transforms according to a mode) for a current prediction mode and then transform indicated by the corresponding index is applied.

The encoder/decoder may apply the secondary transform to the top-left 8×8 region and the right and lower 4×4 regions adjacent thereto. Here, the transform set for 8×8 blocks and the transform set for 4×4 blocks are distinguished and in the embodiment, the encoder/decoder may identify the transform applied to each region by using the same index for 8×8 blocks and 4×4 blocks. Alternatively, as one example, a separate transform set for 4×4 blocks of FIG. 23 may be added.

### Embodiment 8

FIG. 24 is a diagram illustrating a computation method of Givens rotation according to one embodiment of the present disclosure.

As shown in Equation 30 below, the Givens rotation may be expressed as a product of three matrices. Equation 30 corresponds to T_{i,j}⁻¹ in Equation 5 described above and an equation for T_{i,j} may be derived by substituting −θ instead of θ in Equation 30.

$$[ \begin{matrix}cos θ & - s in θ \\ sin θ & cos θ\end{matrix} ] = [ \begin{matrix}1 & p \\ 0 & 1\end{matrix} ] [ \begin{matrix}1 & 0 \\ u & 1\end{matrix} ] [ \begin{matrix}1 & p \\ 0 & 1\end{matrix} ] , where \\ p = \frac{cos θ - 1}{sin θ} , u = sin θ \qquad [ Equation 30 ]$$

By decomposing the Givens rotation as shown in Equation 30, the encoder/decoder may calculate the Givens rotation by using FIG. 24(b) instead of FIG. 24(a). In this case, it is advantageous in that the number of multiplications may be reduced by one compared with a simple matrix multiplication of FIG. 24(a).

If the Givens rotation is configured by the scheme shown in Equation 30 and θ is quantized (e.g.,

$$\frac{2 π \times k}{K} , k = 0 , 1 , \text{...} , K - 1$$

and quantization at K levels), a table for p and u of Equation 30 is required instead of cos θ and sin θ. In this case, p and u of Equation 30 may be quantized at K levels similarly.

The scheme of Equation 30 is the same as the scheme in which a matrix of exchanging two inputs is added to a right side as shown in Equation 31 below for the reflection. Accordingly, prior to applying the operation of FIG. 24(b), the encoder/decoder may exchange an upper input and a lower input.

$$[ \begin{matrix}- sin θ & cos θ \\ cos θ & sin θ\end{matrix} ] = [ \begin{matrix}1 & p \\ 0 & 1\end{matrix} ] [ \begin{matrix}1 & 0 \\ u & 1\end{matrix} ] [ \begin{matrix}1 & p \\ 0 & 1\end{matrix} ] [ \begin{matrix}0 & 1 \\ 1 & 0\end{matrix} ] , \\ where \\ p = \frac{cos θ - 1}{sin θ} , u = sin θ \qquad [ Equation 31 ]$$

Equation 31 corresponds to T_{i,j}⁻¹ in Equation 5 described above and an equation for T_{i,j} may be derived by substituting −θ instead of θ in Equation 30. When θ is quantized,

$$\frac{2 π \times ( K - k )}{K} , k = 0 , 1 , \text{...} , K - 1$$

is substituted instead of

$$\frac{2 π \times k}{K} ,$$

and as a result, a calculation for T_{i,j} may be performed.

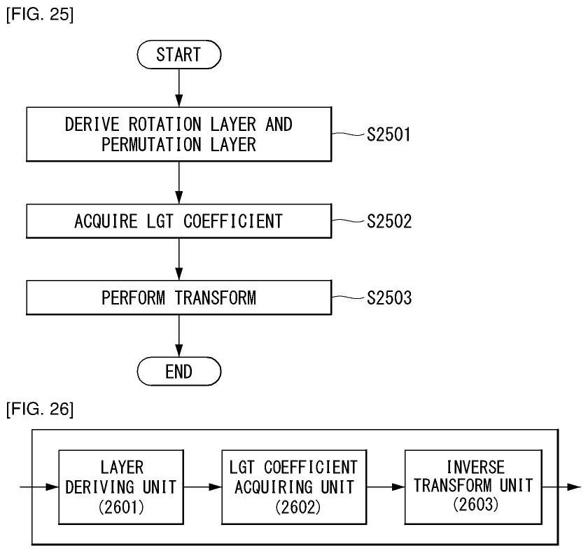

FIG. 25 is a flowchart for describing a process of performing transform using Layered Givens Transform according to one embodiment of the present disclosure.

The encoder/decoder derives a plurality of rotation layers and at least one permutation layer (S2501). Here, the rotation layer may include a permutation matrix and a rotation matrix and the rotation matrix may include at least one pairwise rotation matrix.

The encoder/decoder acquires an LGT coefficient by using the plurality of rotation layers and at least one permutation layer (S2502).

The encoder/decoder performs transform/inverse transform by using the LGT coefficient (S2503). The rotation layer may be derived based on edge information indicating a pair to which the at least one pairwise rotation matrix is applied.

Further, as described in FIGS. 10 to 12 above, the edge information may include one of indexes and each index corresponds to one of the plurality of rotation layers and the index may indicate a specific edge set in a predefined edge set group.

Further, as described in FIGS. 10 to 12 above, step S2501 may include a step of splitting the plurality of rotation layers into sublayer groups. In this case, the edge information may include one of indexes and each index corresponds to one of the sublayer groups, and the index may indicate a specific edge set pattern among predefined edge set patterns and the edge set pattern may represent an edge set group in which an order between edge sets is determined.

Further, as described in FIGS. 13 to 16 above, the edge information may include an index indicating a specific edge for each vertex of the rotation layer.

Further, as described in FIGS. 13 to 16 above, step S2501 may include a step of splitting vertexes of the plurality of rotation layers into sub groups. In this case, the edge information may include connection information between the sub groups and connection information between vertexes in the sub group.

Further, as described in Embodiment 5 above, step S2501 may include a step of determining whether the pairwise matrix is a rotation matrix or a reflection matrix.

FIG. 26 is a diagram more specifically illustrating a decoder according to the present disclosure.

Referring to FIG. 26, the decoder implements the functions, procedures, and/or methods proposed in FIGS. 4 to 25 above. Specifically, the decoder may include a layer deriving unit 2601, an LGT coefficient acquiring unit 2602, and an inverse transform unit 2603.

The layer deriving unit 2601 derives a plurality of rotation layers and at least one permutation layer. Here, the rotation layer may include a permutation matrix and a rotation matrix and the rotation matrix may include at least one pairwise rotation matrix.

The LGT coefficient acquiring unit 2602 acquires an LGT coefficient by using the plurality of rotation layers and at least one permutation layer.

The inverse transform unit 2603 performs inverse transform by using the LGT coefficient. The rotation layer may be derived based on edge information indicating a pair to which the at least one pairwise rotation matrix is applied.

Further, as described in FIGS. 10 to 12 above, the edge information may include one of indexes and each index corresponds to one of the plurality of rotation layers and the index may indicate a specific edge set in a predefined edge set group.

Further, as described in FIGS. 10 to 12 above, the layer deriving unit 2601 may split the plurality of rotation layers into sublayer groups. In this case, the edge information may include one of indexes and each index corresponds to one of the sublayer groups, and the index may indicate a specific edge set pattern among predefined edge set patterns and the edge set pattern may represent an edge set group in which an order between edge sets is determined.

Further, as described in FIGS. 13 to 16 above, the edge information may include an index indicating a specific edge for each vertex of the rotation layer.

Further, as described in FIGS. 13 to 16 above, the layer deriving unit 2601 may split vertexes of the plurality of rotation layers into sub groups. In this case, the edge information may include connection information between the sub groups and connection information between vertexes in the sub group.

Further, as described in Embodiment 5 above, the layer deriving unit 2601 may determine whether the pairwise matrix is a rotation matrix or a reflection matrix.

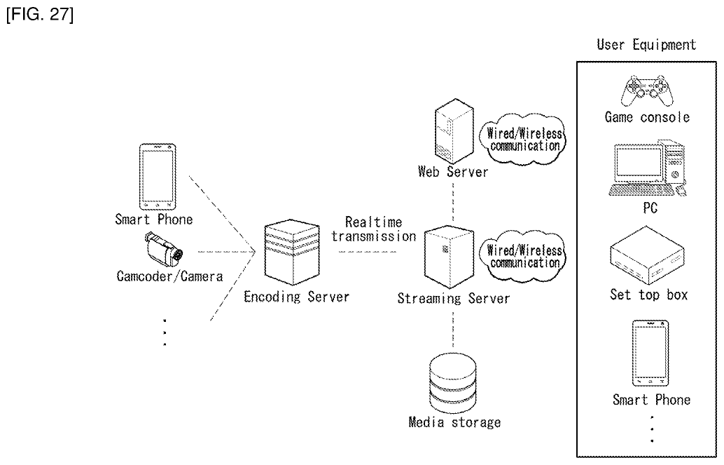

FIG. 27 is a structure diagram of a content streaming system according to one embodiment of the present disclosure.

Referring to FIG. 27, the content streaming system to which the present disclosure is applied may largely include an encoding server, a streaming server, a web server, a media storage, a user device, and a multimedia input device.

The encoding server compresses contents input from multimedia input devices including a smartphone, a camera, a camcorder, etc., into digital data to serve to generate the bitstream and transmit the bitstream to the streaming server. As another example, when the multimedia input devices including the smartphone, the camera, the camcorder, etc., directly generate the bitstream, the encoding server may be omitted.

The bitstream may be generated by the encoding method or the bitstream generating method to which the present disclosure is applied and the streaming server may temporarily store the bitstream in the process of transmitting or receiving the bitstream.

The streaming server transmits multimedia data to the user device based on a user request through a web server, and the web server serves as an intermediary for informing a user of what service there is. When the user requests a desired service to the web server, the web server transfers the requested service to the streaming server and the streaming server transmits the multimedia data to the user. In this case, the content streaming system may include a separate control server and in this case, the control server serves to control a command/response between respective devices in the content streaming system.

The streaming server may receive contents from the media storage and/or the encoding server. For example, when the streaming server receives the contents from the encoding server, the streaming server may receive the contents in real time. In this case, the streaming server may store the bitstream for a predetermined time in order to provide a smooth streaming service.

Examples of the user device may include a cellular phone, a smart phone, a laptop computer, a digital broadcasting terminal, a personal digital assistants (PDA), a portable multimedia player (PMP), a navigation, a slate PC, a tablet PC, an ultrabook, a wearable device such as a smartwatch, a smart glass, or a head mounted display (HMD), etc., and the like.

Each server in the content streaming system may be operated as a distributed server and in this case, data received by each server may be distributed and processed.

As described above, the embodiments described in the present disclosure may be implemented and performed on a processor, a microprocessor, a controller, or a chip. For example, functional units illustrated in each drawing may be implemented and performed on a computer, the processor, the microprocessor, the controller, or the chip.

In addition, the decoder and the encoder to which the present disclosure may be included in a multimedia broadcasting transmitting and receiving device, a mobile communication terminal, a home cinema video device, a digital cinema video device, a surveillance camera, a video chat device, a real time communication device such as video communication, a mobile streaming device, storage media, a camcorder, a video on demand (VoD) service providing device, an (Over the top) OTT video device, an Internet streaming service providing devices, a 3 dimensional (3D) video device, a video telephone video device, a transportation means terminal (e.g., a vehicle terminal, an airplane terminal, a ship terminal, etc.), and a medical video device, etc., and may be used to process a video signal or a data signal. For example, the Over the top (OTT) video device may include a game console, a Blu-ray player, an Internet access TV, a home theater system, a smartphone, a tablet PC, a digital video recorder (DVR), and the like.

In addition, a processing method to which the present disclosure is applied may be produced in the form of a program executed by the computer, and may be stored in a computer-readable recording medium. Multimedia data having a data structure according to the present disclosure may also be stored in the computer-readable recording medium. The computer-readable recording medium includes all types of storage devices and distribution storage devices storing computer-readable data. The computer-readable recording medium may include, for example, a Blu-ray disc (BD), a universal serial bus (USB), a ROM, a PROM, an EPROM, an EEPROM, a RAM, a CD-ROM, a magnetic tape, a floppy disk, and an optical data storage device. Further, the computer-readable recording medium includes media implemented in the form of a carrier wave (e.g., transmission over the Internet). Further, the bitstream generated by the encoding method may be stored in the computer-readable recording medium or transmitted through a wired/wireless communication network.

In addition, the embodiment of the present disclosure may be implemented as a computer program product by a program code, which may be performed on the computer by the embodiment of the present disclosure. The program code may be stored on a computer-readable carrier.

In the embodiments described above, the components and the features of the present disclosure are combined in a predetermined form. Each component or feature should be considered as an option unless otherwise expressly stated. Each component or feature may be implemented not to be associated with other components or features. Further, the embodiment of the present disclosure may be configured by associating some components and/or features. The order of the operations described in the embodiments of the present disclosure may be changed. Some components or features of any embodiment may be included in another embodiment or replaced with the component and the feature corresponding to another embodiment. It is apparent that the claims that are not expressly cited in the claims are combined to form an embodiment or be included in a new claim by an amendment after the application.

The embodiments of the present disclosure may be implemented by hardware, firmware, software, or combinations thereof. In the case of implementation by hardware, according to hardware implementation, the exemplary embodiment described herein may be implemented by using one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, TVs, set-top boxes, computers, PCs, cellular phones, smart phones, and the like.

In the case of implementation by firmware or software, the embodiment of the present disclosure may be implemented in the form of a module, a procedure, a function, and the like to perform the functions or operations described above. A software code may be stored in the memory and executed by the processor. The memory may be positioned inside or outside the processor and may transmit and receive data to/from the processor by already various means.

It is apparent to those skilled in the art that the present disclosure may be embodied in other specific forms without departing from essential characteristics of the present disclosure. Accordingly, the aforementioned detailed description should not be construed as restrictive in all terms and should be exemplarily considered. The scope of the present disclosure should be determined by rational construing of the appended claims and all modifications within an equivalent scope of the present disclosure are included in the scope of the present disclosure.

### INDUSTRIAL APPLICABILITY

Hereinabove, the preferred embodiments of the present disclosure are disclosed for an illustrative purpose and hereinafter, modifications, changes, substitutions, or additions of various other embodiments will be made within the technical spirit and the technical scope of the present disclosure disclosed in the appended claims by those skilled in the art.

1. A method for performing decoding using a Layered Givens Transform (LGT), the method comprising:
deriving a plurality of rotation layers and at least one permutation layer, wherein the rotation layer includes a permutation matrix and a rotation matrix, and the rotation matrix includes at least one pairwise rotation matrix;
acquiring an LGT coefficient using the plurality of rotation layers and the at least one permutation layer; and
performing inverse transform using the LGT coefficient,
wherein the rotation layer is derived based on edge information indicating a pair to which the at least one pairwise rotation matrix is applied.

2. The decoding method of claim 1, wherein the edge information includes one of indexes, each index corresponding to one of the plurality of rotation layers, and
wherein the one of indexes indicates a specific edge set in a predefined edge set group.

3. The decoding method of claim 1, wherein the deriving of the plurality of rotation layers and the permutation layer includes dividing the plurality of rotation layers into sublayer groups,
wherein the edge information includes one of indexes, each index corresponding to one of the sublayer groups, and
wherein the one of the indexes indicates a specific edge set pattern among predefined edge set patterns and the edge set pattern represents an edge set group in which an order between edge sets is determined.

4. The decoding method of claim 1, wherein the edge information includes an index indicating a specific edge for each vertex of the rotation layer.

5. The decoding method of claim 1, wherein the deriving of the plurality of rotation layers and the permutation layer includes dividing vertexes of the plurality of rotation layers into sub groups, and
wherein the edge information includes connection information between the sub groups and connection information between vertexes in the sub group.

6. The decoding method of claim 1, wherein the deriving of the plurality of rotation layers and the permutation layer includes
determining whether the pairwise rotation matrix is a rotation matrix or a reflection matrix.

7. An apparatus performing decoding using Layered Givens Transform (LGT), the apparatus comprising:
a layer deriving unit deriving a plurality of rotation layers and at least one permutation layer, wherein the rotation layer includes a permutation matrix and a rotation matrix, and the rotation matrix includes at least one pairwise rotation matrix;
an LGT coefficient acquiring unit acquiring an LGT coefficient using the plurality of rotation layers and the at least one permutation layer; and
an inverse transform unit performing inverse transform using the LGT coefficient,
wherein the rotation layer is derived based on edge information indicating a pair to which the at least one pairwise rotation matrix is applied.

8. The decoding apparatus of claim 7, wherein the edge information includes one of indexes, each index corresponding to one of the plurality of rotation layers, and
wherein the one of indexes indicates a specific edge set in a predefined edge set group.

9. The decoding apparatus of claim 7, wherein the layer deriving unit divides the plurality of rotation layers into sublayer groups,
wherein the edge information includes one of indexes, each index corresponding to one of the sublayer groups, and
wherein the index indicates a specific edge set pattern among predefined edge set patterns and the edge set pattern represents an edge set group in which an order between edge sets is determined.

10. The decoding apparatus of claim 7, wherein the edge information includes an index indicating a specific edge for each vertex of the rotation layer.

11. The decoding apparatus of claim 7, wherein the layer deriving unit divides vertexes of the plurality of rotation layers into sub groups, and
wherein the edge information includes connection information between the sub groups and connection information between vertexes in the sub group.

12. The decoding apparatus of claim 7, wherein the layer deriving unit determines whether the pairwise rotation matrix is a rotation matrix or a reflection matrix.

13. A method for performing encoding using a Layered Givens Transform (LGT), the method comprising:
deriving a plurality of rotation layers and at least one permutation layer, wherein the rotation layer includes a permutation matrix and a rotation matrix, and the rotation matrix includes at least one pairwise rotation matrix;
acquiring an LGT coefficient using the plurality of rotation layers and the at least one permutation layer; and
performing inverse transform using the LGT coefficient,
wherein the rotation layer is derived based on edge information indicating a pair to which the at least one pairwise rotation matrix is applied.
